(19) United States
(12) Patent Application Publication
(10) Pub. No.: US 2006/0085420 A1
(43) Pub. Date: Apr. 20, 2006

(54) Method and apparatus for monitoring real users experience with a website

(75) Inventor: Ching-Fa Hwang, Los Altos Hills, CA (US)

Correspondence Address: BINGHAM, MCCUTCHEN LLP, THREE EMBARCADERO CENTER, 18 FLOOR, SAN FRANCISCO, CA, 94111-4067, US

(73) Assignee: Symphoniq Corp., Palo Alto, CA (US)

(21) Appl. No.: 10/951,480

(22) Filed: Sep. 27, 2004

(51) Int. Cl. G06F 17/30

(52) U.S. Cl. 707/10

(57) ABSTRACT

A method and system for monitoring performance of rendering one or more web pages are described. The embodiments include defining a logical set of web pages by selecting a subset of the pages available on a website, wherein the logical set is identified by a naming string and monitoring a web page of the logical set in response to a user requesting the page for viewing at a client computer, wherein the client computer requests each of the objects of the requested page from one or more server computers. The embodiments further include causing performance data to be collected by a client agent and one or more server agents during a composing and presenting of the requested page, wherein the client agent resides and gathers performance data on the client computer and the server agents reside and gather performance data on the server computers and diagnosing problems experienced by the user in viewing the requested page by correlating the performance data collected by the client agent and the server agents.

### CROSS-REFERENCE TO CD-ROM APPENDIX

An Appendix containing a computer program listing is submitted on a compact disk, which is herein incorporated by reference in its entirety. The total number of compact discs including duplicates is one. The disk includes the following file in ASCII format:

| | |
|---|---|
| 09/23/2004 04:31 PM | 50,242 cprobe100.js |

| | |
|---|---|
| 1 File(s) | 50,242 bytes |
| 0 Dir(s) | 0 bytes free |

This listing contains material which is subject to copyright protection. The copyright owner has no objection to the facsimile reproduction by anyone of the patent document or the patent disclosure, as it appears in the patent and trademark office patent file or records, but otherwise reserves all copyright rights whatsoever.

### FIELD

Embodiments of the invention relate to monitoring website performance, specifically monitoring real-time user experiences when viewing a website.

### BACKGROUND

In the last decade the Internet based on HTML (HyperText Markup Language) and HTTP (Hypertext Transport Protocol) of the WWW (World Wide Web) standards has become the new wave of client-server computing platforms, and has become the predominant IT (Information Technology) infrastructure for companies to offer goods and services to their customers. Unlike conventional client-server platforms, where a single or a small number of vendors provide all necessary client computer and server components, e.g. SAP™, IBM CICS™, Lotus Domino™, Microsoft Exchange™, etc., the Internet separates the client-server components, namely user browsers and Web servers based on HTML and HTTP communication, from the content, such as content providers of various goods and services of ecommerce, on-line banking, on-line travel, etc. for external customers; and Web-based CRM, ERP, or other applications for internal customers and business partners.

The unprecedented popularity of the Internet with millions of users around the world and an almost infinite number of permutations of platform offerings and content providers generates new business opportunities but also management challenges that warrant more advanced solutions than those for conventional client-server management. Many management vendors have either upgraded their existing solutions or created a new set of solutions to address this new market, but few vendors can provide satisfactory monitoring solutions to address the new management challenges in particular real users experience with performance.

The challenges are two-fold. The first challenge is to identify a logical set of Web pages to be monitored. A typical site can have hundreds or even thousands of distinct Web pages. The number can easily increase by one to two orders of magnitude when considering most sites nowadays employ dynamic pages that are dynamically generated based on user input (e.g. the user's selection of travel destinations, date, and other options for an on-line travel site). Most monitoring solutions are focused on monitoring a fixed list of individually identified pages, e.g. a home page, shopping cart page, a search page, etc. Even if the number of individually identified and monitored pages is allowed to rise into 10's or 100's, this would still only monitor a fraction of the total number of possible pages. The burden is placed on the people using those solutions for monitoring their Website to properly select and project those pages where problems may occur, involving lots of guess work. Any problems occurring on pages outside those selected pages are missed and thus are like “hidden problems” from those monitoring solutions.

In addition, the solutions relying on monitoring pages that are individually identified fail to take advantage of the fact that most Websites are organized into logical functions, i.e. logical groups.

Business people care more about real users experiences with the goods and services offered by the company's Website, while IT people focus on managing the health and performance of the servers and machines of the Website infrastructure. It is necessary to align priorities of the IT people with the business objectives. Although some management solution vendors are engaged in enabling an alignment between IT and business people, their solutions tend to involve expensive and time-consuming mapping to relate real users experience by business functions to the health of IT infrastructure components. What is needed is a way to easily and directly relate real users experience to the performance of the Website and its infrastructure components based on the logical groups.

Once Web pages at a Website can be identified in logical groups the next challenge is to handle monitoring of real users experience for the thousands or even millions of real users of the Website and diagnosing problems in each logical group. In general, management vendors for monitoring the users experience in the industry have adopted client-based solutions, server-based solutions, or a combination of both. Examples of these solutions are provided below.

Client-based monitoring is a popular solution in use today and is provided in two schemes. The first scheme is through the deployment of reference sites acting as simulated client computers and performing synthetic transaction requests against target Web sites. Vendors in this market often place their reference sites around the world to have a good geographical coverage of users. The owner of a Website that offers goods or services on the Internet could come to one of the vendors to make their Website a target for the monitoring service. A fixed set of transactions is selected for such a Website, e.g. simulating a user login to the Website or a transaction of purchasing certain merchandise. The set of synthetic transactions are then issued from the reference sites on a scheduled basis and the performance data from simulated users experience can be measured and made available to the owner of the target Website for analysis. These client-based monitoring solutions are also referred to as synthetic solutions.

This scheme of synthetic, client-based monitoring provides a well-defined means to monitor a target Website's performance. However, the coverage can only simulate and represent a fraction of real users and transactions hitting a target Website, compared to the thousands to millions of the real users performing real transactions. Although many Websites use this service for benchmarking against their competitors in the market, they cannot depend on it for diagnosing real user problems. Specifically, it can be directed to only a small number of Web pages that may cause problems but cannot detect the vast majority of the other pages that are not included for monitoring.

The other scheme of client-based monitoring is based on client agents often offered as a software product to be installed at selected client computers of the users of a Website. However, they can only be installed with those users who have granted permission for the installation and monitoring of their client computers, i.e., registered users of the Website that are willing to cooperate. Moreover, the users' client computers may be required certain minimum capacity or proper run-time environments to support the install process. While it provides flexibility to place the agents wherever desired as opposed to the first scheme of vendor-provided reference sites it is intrusive and requires user permission that may be possible only from a limited group of users. It is not a general solution for monitoring and diagnosing real users experience problems outside the limited group of users.

Yet another form of installing client-based agents is to embed the monitoring software in the HTML Web pages to be downloaded to each client computer accessing such Web pages. The software embedded is likely to be in JavaScript, VB Script, or other languages that do not require any run-time environment to be installed first other than a common Web browser. A selected set, if not all, of Web pages of a target Website can be edited to embed such software, which is to be executed by a client computer's browser receiving those Web pages. It may require significant efforts from a target Web site to edit its Web pages and test them for correctness. Even though such a process may be assisted with automated editing tools it is still time-consuming and can introduce potential errors to Web pages and thus affect the stability of production Websites.

Server-based solutions, on the other hand, have the monitoring done on the server side and are transparent to users of a target Website. There is no need to install any agent on the client computer side, nor to modify any Web pages. The agent is either installed on each of the monitored servers (such as Web servers) or attached to a network or a network device such as a proxy filtering the traffic in and out of the servers connected with the network. While the server agent, if properly installed, can see all traffic coming out of all real users of a target Website, it is limited to the data that can be gathered on the server side. Users experience with performance and exceptions that can be monitored only at the client computer side is not available from server-based monitoring.

Real users experience with performance (including exceptions) is what a real user sees and experiences when clicking on a URL (Uniform Resource Locator) to render a page for viewing. This includes:
a) how long it takes for the page to start showing up—generally time-to-first-byte;
b) how long it takes for all objects of a page to render and complete the page rendering;
c) thinking time spent on the current page prior to clicking for the next page;
d) exceptions such as, errors, aborts and abandonments during the rendering process.

A major difficulty in monitoring and diagnosing the users experience is the nature of HTTP as a stateless protocol between client computers and servers. The servers at the Website receiving requests for page objects (such as texts, data, and images) have no visibility as to how the objects are put together into the page to be rendered to the requesting client computer. The browser at the client computer executing an HTML file is the one that composes the page by sending and receiving requests for individual objects as defined in the HTML file. However, it has no idea how the requests are traveling over the Internet to the target Website and how an individual server is selected for serving each of the requests.

Hence, neither client-based nor server-based solutions can monitor and diagnose complete users experience unless they are put to work together. When a user experiences bad performance waiting for a page to be rendered it is necessary to first monitor it at the client computer for leading problem indicators such as excessive page rendering times. Next, the transmission over the Internet to the servers needs to be diagnosed for the cause of slow performance. It might be due to the latency of the Internet or the performance slowdown of the Website. For the latter and again due to the stateless nature of the HTTP protocol it is necessary to relate the objects to the page, identify which servers are requested to serve those objects, and determine among the servers which ones are responsible for the slow object service times.

In summary, a Website often consists of a very large number of Web pages that are likely organized into logical groups. Most existing solutions can only be directed to monitor a small number of selected pages within each logical group, and thus often miss most of the problems that occurred on the vast majority of the pages that are not selected. In addition, the monitoring solution based on logical groups needs to be a combination of client-based monitoring and server-based monitoring in order to be able to correlate data from both to capture real users experience. When a problem related to a logical group of Web pages occurs it is necessary to diagnose the problem from the client computer to the Internet and then the Website. And if the problem is with the Website its necessary to identify which servers are serving the objects of the problematic page. However, none of those existing solutions can provide this level of monitoring and diagnosis.

Moreover, a typical Website may be based on an infrastructure of multi-tiered servers to serve the objects, such as Web server, application servers, Database servers and other types of servers. Those servers collectively are responsible for serving the requests for objects for composing Web pages. Hence, when there is a performance problem with a Website serving a page comprised with multiple objects it is necessary for diagnosis to find out among the objects which ones incurred the slowest serving times and among the multi-tiered servers which servers are attributable to these serving times.

### SUMMARY

A method and system for monitoring performance of rendering one or more web pages are disclosed. A logical set of web pages is defined by selecting a subset of the pages available on a website, wherein the logical set is identified by a naming string. A web page of the logical set is monitored in response to a user requesting the page for viewing at a client computer, wherein the client computer requests each of the objects of the requested page from one or more server computers. Performance data is collected by a client agent and one or more server agents during a composing and presenting of the requested page, wherein the client agent resides and gathers performance data on the client computer and the server agents reside and gather performance data on the server computers. Problems experienced by the user in viewing the requested page are diagnosed by correlating the performance data collected by the client agent and the server agents.

### BRIEF DESCRIPTIONS OF THE DRAWINGS

The embodiments of the invention are illustrated by way of example and not limitation in the figures of the accompanying drawings, in which like references indicate similar elements and in which:

FIG. 1 illustrates a distributed network of users at client computers accessing a Website of servers according to some embodiments of the invention. The distributed network may include the Internet, intranets, and extranets;

FIG. 2 shows a Web browser at a user's client computer that communicates with multiple Web servers to compose and render a Web page according to some embodiments of the invention. The base page and the embedded objects may be served by multiple Web servers at the Website. And the browser with the HTML page may know how the various objects are fit into the Web page framework;

FIG. 3 illustrates how a new logical set as a subset of an existing logical set is automatically generated and identified for further problem monitoring at a higher sampling rate according to some embodiments of the invention. Different sampling rates may be used for logical sets with different scopes;

FIG. 4A shows how the event handler of OnClick and OnLoad of the client agent are used to handle normal operations when the user clicks and views from one page to the next, barring from exceptions according to some embodiments of the invention;

FIG. 4B shows how a page is comprised of two frames according to some embodiments of the invention. The loading of the page 1 may not be done until frame#1 and frame#2 are completely loaded. Then, frame#1 and frame#2 may be separately clicked, rendered, and monitored;

FIG. 5A shows how a Web page for monitoring causes a unique page ID (PID) to be generated and placed in a cookie created for the monitoring purpose between a server agent and a client agent according to some embodiments of the invention. Although the objects on the page may be distributed to multiple Web servers, the PID in the cookie always goes with each request to the server agent for correlating the performance data and exceptions of the base page and all its objects;

FIG. 5B shows communications between the server agent and the client agent created by the server agent for the page selected for monitoring according to some embodiments of the invention;

FIG. 6A shows four tags to be inserted to the HTML in a multi-step download of the client agent JavaScript according to some embodiments of the invention;

FIG. 6B shows a copy of the client agent's JavaScript as loaded in by Tag 3, in addition to the OnLoad and OnClick event handlers according to some embodiments of the invention;

FIG. 7A illustrates measurements for a normal rendering process where the user clicks and views from one page to the next according to some embodiments of the invention. The performance data by the client agent and the server agent may be correlated together;

FIG. 7B shows an exception of this when the click event is not received according to some embodiments of the invention;

FIG. 7A.1 shows an exception where the page rendering is interrupted by exceptions such as a user's click-ahead for the next page according to some embodiments of the invention;

FIG. 7A.2 shows an exception where the page rendering is interrupted by a new URL entered according to some embodiments of the invention;

FIG. 7A.3 shows an exception where the page rendering is interrupted by the Refresh button clicked by the user according to some embodiments of the invention;

FIG. 8 shows the case of a performance threshold violation and its Top N detail information that are provided based on the data gathered by the client agent and the server agent according to some embodiments of the invention;

FIG. 9A illustrates an example where a Web page's rendering time is detected to be too long as caused by long rendering times of some object(s) embedded in the page according to some embodiments of the invention;

FIG. 9B shows that Object A is marked for trace and is traced by the ASP for times spent on the tiered servers according to some embodiments of the invention;

FIG. 10 illustrates a conventional processing system according to some embodiments of the invention.

### DETAILED DESCRIPTION

Methods and apparatuses for website performance monitoring are described. Note that in this description, references to “one embodiment,” “an embodiment” or “some embodiments” mean that the feature being referred to is included in at least one embodiment of the invention. Further, separate references to “one embodiment” or “some embodiments” in this description do not necessarily refer to the same embodiment(s); however, neither are such embodiments mutually exclusive, unless so stated and except as will be readily apparent to those skilled in the art. Thus, the invention can include any variety of combinations and/or integrations of the embodiments described herein.

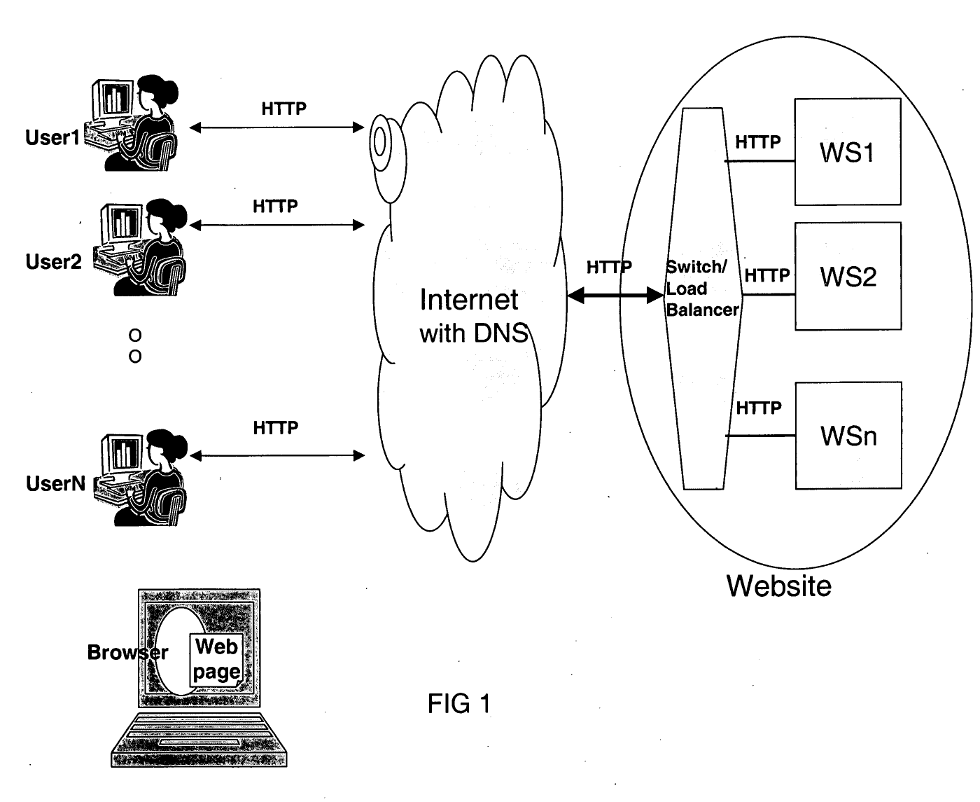

A distributed network environment can be represented by the Internet that connects millions of users using their client computers with millions of Websites and servers. FIG. 1 shows how users using their client computers connect to the Internet to access Web servers at a Website according to some embodiments of the invention. A Domain Name Service (or DNS) is available on the Internet as a distributed naming service that enables a user at a client computer to locate and access a Website by specifying a domain name, e.g. www.MyCommerce.com. A Website consisting of multiple servers usually uses a switch or load balancer in front of the Web servers to direct each of users' requests to one of the servers.

Each of the client computers is typically running a Web browser for rendering Web pages and communicating with a server computer running a Web server via the HTTP communication protocol (including HTTPS as a secured version of HTTP). A server running the Web server software is generally referred to as a Web server to differentiate from other servers running different types of server software (such as application or Database). Popular Web browser software in the market includes Microsoft Internet Explorer™ (or IE), Netscape™, Mozilla™, etc. Popular Web server software includes Microsoft Internet Information Server™ (or IIS), Apache™, iPlanet™, etc.

Embodiments of the invention may be applied to intranets, which are used within a company's enterprise environment, or extranets between one company and another company. Similar client and server computers may be configured to communicate with each other with the help of a private DNS or similar naming services.

Embodiments of the invention may also be applied to other HTML and HTTP compliant devices used by users to access a Website. Similarly they may be applied to other types of electronic data, other than Web pages, that may be used for data exchange between one computer and another computer communicating via the HTTP or similar communication protocol.

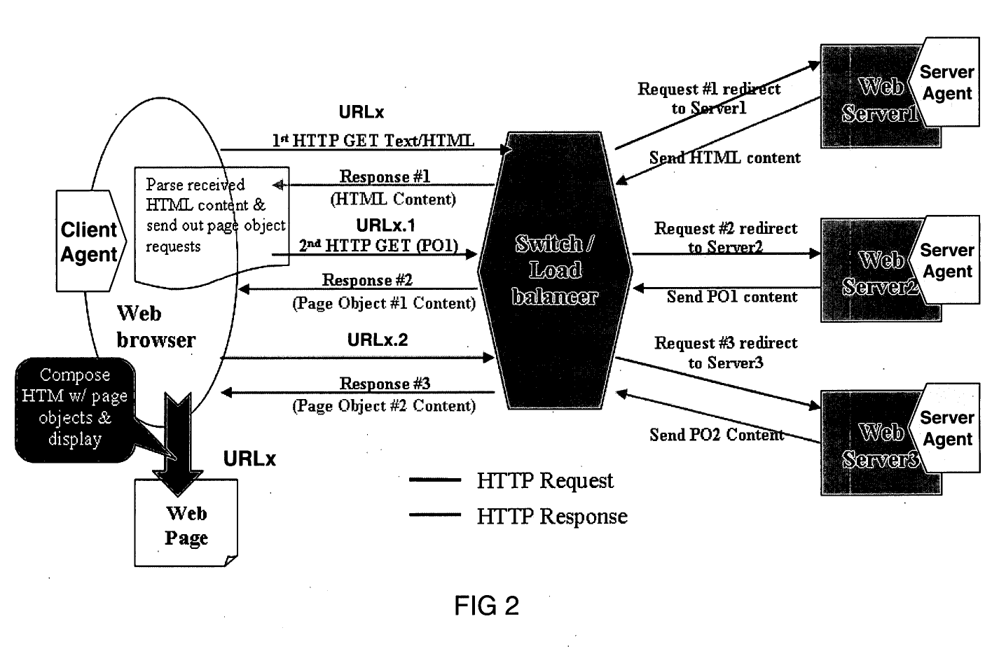

FIG. 2 illustrates a process of a user requesting a Web page to be brought in and rendered by the Web browser according to some embodiments of the invention. It assumes there are three requests to be sent and responded between the browser and the Web servers involved. The first request of URLx is for the Web page itself in HTML format (which is referred to as an HTML base page or just a base page) that defines how the page is composed of and is embedded with two page objects (such as images) to be brought in next. The browser upon receiving the HTML base page parses the HTML text to start displaying the Web page on the window of the client computer and sends out two requests of URLx.1 and URLx.2 for the two embedded objects, and determines the positions on the page where each object is to be rendered. The HTML page serves as the reference for composing the Web page embedded with the objects. It will be appreciated by one skilled in the art that other requests may be transmitted between the browser and the server and the embodiments of the invention are not limited to the three requests described above.

For performance and load balancing a Website usually is architected to utilize multiple Web servers that can serve the requests for HTML base pages and for the objects embedded in each page. FIG. 2 shows three Web servers that are called upon to provide such services according to some embodiments of the invention. Due to the stateless nature of HTTP protocol, these Web servers work independently to fulfill requests, while the Browser with knowledge from parsing the HTML page knows how various objects are fit into the Web page framework.

The user experience with a Web page, starting from the time the first request is first sent to the time the page's rendering started, the time the objects filled in one after another, all the way to the time the page is fully rendered, can only be monitored and measured at the client computer side. Any monitoring solution solely based on the data gathered at the server side cannot get complete user experience. Moreover, some of the errors and exceptions, such as user aborts and abandonments, caused or experienced at the client computer side are completely hidden from the servers or any monitoring at the server side. This helps establish the need to bring in the knowledge and measurements from the client computer by client-side monitoring with those by server-side monitoring to provide a complete picture as the users see it.

Embodiments of the invention may be applied to monitoring user experience and problem diagnosis with more than one Web page of a “transaction”. A transaction may comprise more than one Web page ordered in a certain sequence. Upon a user requesting a sequence of Web pages that matches a predefined transaction the rendering time of each of the pages is measured and accumulated together to obtain the rendering time of the entire transaction.

Embodiments of the invention may also be applied to user experience dealing with statistics other than performance. This includes user behavior analysis that keeps track of user traffic patterns through related Web pages at a Website, for example, the % of user requests going from one Web page to another page that leads to a successful transaction with the Website, such as a successful online purchase; the % of users failed to complete a successful transaction with the Website; and the times that the users spent on each page and transaction. One skilled in the art can appreciate that the performance data collected for the invention may be used to obtain such statistics for user behavior analysis.

In some embodiments of the invention the client-based agent for client-side monitoring is referred as the client agent and the server-based agent for server-side monitoring as the server agent, as included in FIG. 2. Both the client agent and the server agent work together to provide complete performance data.

In some embodiments logical sets of Web pages are used to define the scope for monitoring and diagnosing problems. Each logical set of Web pages represents a number of related Web pages and is identified by one logical name. Each logical group can be monitored in its entirety and any problems occurring within the logical group can be diagnosed. Specific pages within a logical set that users have experienced problems with are determined. And necessary performance data for those pages is provided to help IT users resolve the problems and improve general users experience.

Logical sets are often set up by IT users of the monitoring solutions corresponding to the logical groups of a Website. For example, an on-line travel site may be functionally organized into four functional groups for travel reservations, each identified by an URL naming string as defined below with wild cards:

www.MyTravelSite.com/flights/*

www.MyTravelSite.com/cars/*

www.MyTravelSite.com/hotels/*

www.MyTravelSite.com/vacations/*

Hence, all Web pages concerning flights may be identified and monitored by the URL naming string of “/flights/*”, such as

www.MyTravelSite.com/flights/round-trip/search?from=sjc % to=nyc % from-date=12/1/04% return-date=Dec. 4, 2004

www.MyTravelSite.com/flights/cancels/confirmation?number=1221

www.MyTravelSite.com/flights/change-reservations/login.asp

If the on-line travel site on the other hand is organized by operations all Web pages related to operations on flights may be identified and monitored by the URL naming string of “*flights*”, such as

www.MyTravelSite.com/prepare-flights.index

www.MyTravelSite.com/MyAccount/change-flights?confirmation?number=1221% new-date=Oct. 1, 2004

Similar examples can be applied to other functions or operations for travel reservations.

To specify monitoring of all Web pages, a URL naming string of “*” may be used, which causes all pages at the target Website to be monitored, such as

WWW.MyTravelSite.com/*

In some embodiments a URL naming string can be also expressed in regular expressions. For example, all confirmations made in the first half of December '04 may be monitored through the URL naming string of “*confirmation*date=Dec.[1-15]*2004*”

This can be applied to the following examples:

www.MyTravelSite.com/confirm-flights/confirmation?from=SJC % to=nyc % date=Dec. 3, 2004

www.MyTravelSite.com/confirm-cars/confirmation?size=mid % date=Dec. 10, 2004

Regular expressions are a superset of wild cards and are more flexible and powerful. One skilled in the art can appreciate that regular expressions provide a convenient way for defining and structuring URL naming strings in regular expressions with wild cards, partial matches, ranges based on value or alphanumericals, etc. Specifications of regular expressions can be found in the following documents:
sunland.gsfc.nasa.gov/info/regex/Top.html
etext.lib.virginia.edu/helpsheets/regex.html

According to some embodiments, the more Web pages are chosen the more overhead may be incurred by the monitoring solution in terms of processing, network, and storage overhead. It may be expensive to monitor all user accesses to every Web page and provide performance data. An alternative is to support a monitoring and sampling criteria so that the user accesses of a page may be filtered for monitoring at a sampling rate of less than 100% to maintain a reasonable overhead to the Website and reasonable resource consumption by the monitoring solution. In some embodiments, if a logical set of Web pages is set at 50% it means 50% of accesses to each page in the logical set are monitored. In some embodiments, an adaptive monitoring and sampling is used, which includes varying the sampling rate based on the scope of the logical set being monitored. For example, the following are four logical sets identified by four URL naming strings in regular expression for monitoring:

1) “*” wild card for all Web pages as the broadest logical set

2) logical sets such as “/sales/*” for all pages under the sales umbrella

3) logical sets such as “/sales/support/*”, “/sales/customers/*” under the /sales/* above

4) individual Web pages such as “/sales/login.html”, or “/sales/partners/index.html” as the smallest logical set of one page

According to some embodiments, the sampling rates are divided into various levels based on the scope of each logical set, such as low at 10%, medium at 25%, 50%, or 75% and high (or full) at 100%. An IT user defining a logical set for monitoring can assign a sampling rate for each of such logical sets. For example, for the logical set presented above, the IT user may assign the following sampling rates: low sampling for the encompassing monitoring of “*”, medium sampling for the umbrella type, and full sampling for the specific Web page monitoring.

In some embodiment the sampling rate may also be determined based on the resource consumption of a client computer hosting the client agent or a server computer hosting the server agent. If a hosting computer is reaching a high utilization of its resources, e.g., CPU % greater than 90%, the monitoring may be set at a lower sampling rate to help conserve the resources used for the monitoring purpose. This lowering of sampling rate can be applied to all or some of the logical sets of pages being monitored. On the other hand, if the resource consumption is below a certain level, e.g. CPU % less than 80%, the agent may be set to a higher sampling rate.

According to some embodiments of the invention, a new logical set is automatically identified as a subset from an existing logical set where problem(s) is detected for further monitoring. This is done when problems are detected on a page of an existing logical set. Multiple pages where problems are detected are combined into a subtree of the existing logical set as a new logical set for monitoring and identified by a new naming string. The purpose is to focus more on a subset of the pages for problem monitoring at a higher sampling rate. To reduce the number of newly created logical sets, a threshold is set up so that only pages with more problems detected than the threshold within a time period are grouped together as a new logical set according to some embodiments. If problems occurred to a particular single page persistently over a time period that single page may be also formed as a logical set for monitoring perhaps at a higher or 100% sampling rate. As a result, a sampling rate is applied to each newly generated logical group depending on its scope and the frequency of problems detected. When no change in the pattern of the problems detected in a newly generated logical set is observed, the sampling rate may be reduced to a lower rate. When anewly generated logical set has not been detected with any problems for a period of time the logical set may be automatically deactivated.

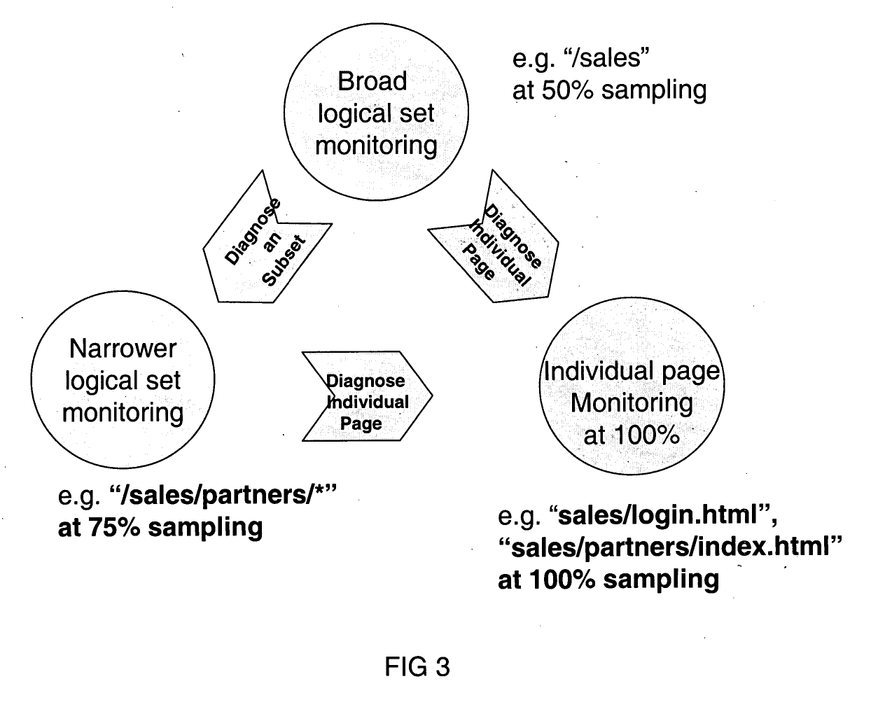

FIG. 3 illustrates a process of automatically generating logical sets and setting respective sampling rates for monitoring according to some embodiments. When a broad logical set such as/sales/* is detected with a problem(s), a narrower logical set such as/sales/customers/* is automatically generated as a subset and monitored initially at a higher sampling rate. It can further zoom in onto a particular page where a problem has occurred persistently. A new logical set is generated for the particular page and monitored initially at 100% sampling rate.

According to some embodiments user accesses to a Website are grouped into business groups (BGs) for monitoring performance. A business group consists of at least one logical set that is defined based on the Website's business functions and operations. For example, an on-line travel site may see its BGs be defined by its travel functions, such as BG-flights, BG-reservations, that may include the following URL naming strings for the logical sets: BG-flights: “/flights/*” to apply to the logical set of all pages under the www.MyTravelSite.com/flights/umbrella including flights search, reservation, bookings, etc.;

BG-reservations: “/flights/*” and “/cars/*” to include all pages under the www.MyTravelSite.com/flights/* and www.MyTravelSite.com/cars/* umbrellas.

For an on-line banking site, there may be two business groups for their on-line banking and mutual fund business, e.g.

BG-Banking: “/*On-lineBanking*/”

BG-MutualFund: “/*MutualFunds*/*”

A BG may also be defined by user operations in an ad-hoc fashion. For example, for an ecommerce site BG-Promotions may be defined for all PC and printer promotions to be monitored for their traffic and performance: “*PCPromotions*” and “*PrinterPromotions*.” A BG may also comprise all Web pages for the Website, such as BG-All with “*” for the Website overall monitoring and problem diagnosis.

In general BGs enable IT people to manage a Website and its infrastructure of servers based on priorities and objectives set for each group with the business people.

In some embodiment the monitoring and sampling criteria may include other criteria than URL naming strings, such as client computer's IP address, client computer's geographical area which may be derived from the IP address, client computer's browser type, client computer's operating system, server name, connection speed, etc. These additional criteria can also be included into business groups. Details are not provided here since it is readily apparent to those skilled in the art.

According to some embodiments, in order to measure users experience the system detects how a page is requested and rendered and what constitutes that page. A user usually requests a page for viewing by clicking a URL link defined within a page, entering a new URL, or selecting a URL predefined with the browser to start the process of rendering the page. If the URL is valid and the browser can communicate with the Website referenced by the URL then the browser starts to bring in the base page, parse and process it, and then load all embedded objects one after another. This rendering process continues until all objects are loaded and the page is fully rendered.

In some embodiments the OnClick and OnLoad events are used for monitoring the beginning and ending of a page's rendering process. According to the W3C (World Wide Web Consortium) (definition can be found at www.w3.orgfTR/REC-html40/interact/scripts.html) OnClick and OnLoad are defined as:

onclick=The onclick event occurs when the pointing device button is clicked over an element.

onload=The onload event occurs when the client agent finishes loading a window or all frames within a frameset. (Note that window here refers to a Web page.)

The definitions of the OnClick and OnLoad events are well known in the art and no further details are necessary.

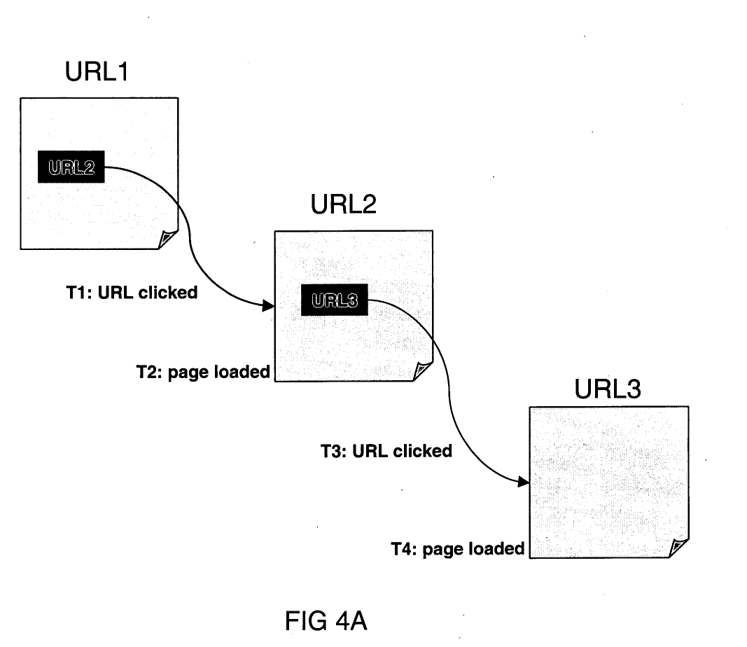

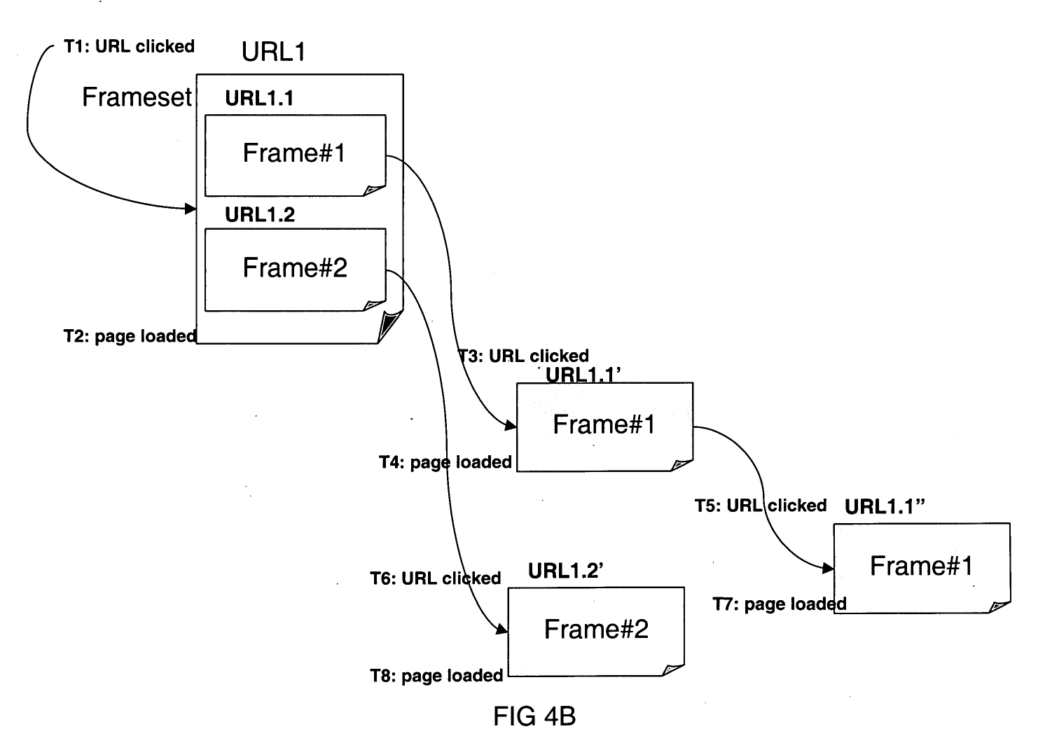

FIG. 4A shows how the OnClick is signaled when a link is clicked by the user for the next page and the OnLoad signaled when a page is rendered according to some embodiments of the invention. The OnClick and the OnLoad event handlers included in the client agent are used for measuring the rendering time of each page, where the user click-and-views from one page to the next, baring any exceptions. Each invocation of the event handler can be used to timestamp the occurrence of each event, which can be used to calculate the delta for the rendering time from a click to a load, e.g. T2-T1 for rendering the page of URL2, and T4-T3 for the page of URL3. While there are other events defined in the W3C specification, such as OnUnload, they may not be as reliable as OnClick and OnLoad in the popular browsers and thus are not described here. However, one skilled in the art will appreciate that other events and event handlers in addition to OnClick and OnLoad may be implemented and used as well.

There are some exceptions to the normal rendering process that are considered according to some embodiments. For example, the rendering of the current page may be interrupted by the user's action, e.g. clicking the Stop or Refresh button, clicking ahead, and entering a new URL, etc., when the rendering takes too long or the content is not of interest, or one of the page objects runs into an error with a Web server that the browser is communicating with. In one embodiment the exceptions are the occasions where the client agent can no longer rely on the OnClick or OnLoad event for gathering page rendering times and the server agent is used for supplementing the measurements for the missing data according to some embodiments of the invention.

There are also complexities in dealing with a page comprised with frames such as a frameset/frame and iframe. Both are used to define a frame like a sub-page within a browser's page that the user is viewing. Frameset/frames and iframes are well known in art and no further details are necessary. Specifications on frameset/frames and iframe can be found on the following websites:

www.w3 .org/TR/REC-html40/present/frames.html#edef-FRAMESET msdn.microsoft.com/library/default.asp?url=/workshop/author/dhtml/reference/collection s/frames.asp

In a way frames function like pages within a page with many of the characteristics of a page and can be rendered, clicked, scrolled, etc. Their composing objects and performance data need to be included in monitoring the Web page that the user is viewing. Once the Web page with all the frames is loaded (or being loaded) the user can click on each frame for rendering as if it were an independent page. In addition the performance of each frame can be selectively monitored as it may be set up by the IT user.

FIG. 4B shows how a page (denoted by URL1) based on frameset is comprised of two frames, frame#1 (denoted by URL1.1) and frame#2 (denoted by URL1.2) according to some embodiments of the invention. The loading of the page is not done until frame#1 and frame#2 are loaded completely, at which point the OnLoad for the page of URL1 is activated to signal the end of its rendering. Thus, the rendering time of URL1 is T2-T1. Now a link within frame#1 could be clicked to load in the same frame the next sub-page (denoted by URL1.1′), which may be monitored just like a separate page, and its rendering time is T4-T3. Another click on the URL1.1′ sub-page may cause the next sub-page (denoted by URL1.1″) to be loaded and monitored, and its rendering time is T7-T5. In parallel, another link within frame#2 could be clicked to load its next sub-page, with its rendering time overlapping that of URL1.1″ or T8-T6, so on and so forth.

In some embodiments, once an instance of a Web page access is identified it is assigned with a unique page ID (or PID). The PID provides means to correlate and integrate all performance data pertaining to the particular instance of the Web page. The performance data collected by the client agent and the server agent are correlated to provide a complete picture of the users experience. Another instance of the same Web page, whether by the same or a different client computer, is assigned with another unique PID.

The PID is unique in both time and space among all users accessing the same page or different pages at a Website and among all distributed client agent and server agent components employed for the Website.

In some embodiments, both the client agent and the server agent work together for enhancing the uniqueness of the PID. This is due to the cache support at the client computer side and/or the server side, where a previously accessed page is cached temporarily and reusable for subsequent accesses. Once a Web page instance is identified, the server agent generates a unique PID for such a page instance and embeds the PID into the base page. The client agent, upon obtaining the PID from the base page, can enhance the uniqueness of the PID by appending it with additional unique ID at the client computer side. Hence, if a Web page embedded with a PID is cached at the server side and made available to multiple users requesting for the same page, the unique ID appended by the client agent helps ensure the uniqueness of the PID for each user access. Likewise, if the page is cached at the client computer side, the unique ID appended by the client agent again helps ensure the uniqueness of the PID for each user access.

In one embodiment the client agent appends the additional unique ID to the PID from the server agent only if the page is from a cache at the client computer or the server computer.

Next, we discuss the formation of the client agent and the server agent and the communications between the two according to some embodiments of the invention. In some embodiments, the server agent is a host-based monitoring module combined with each of the Web servers selected for monitoring users experience and performance, and part of its functions is filtering each HTTP request from users of the Internet. The server agent can gather each request and examine its URL naming string, header information, and cookie, and optionally modify its header before putting it back to its communication path. It can mark the request to be monitored. When the Web server has serviced the request and is ready to send a result back to the user, the server agent again can intercept the result, filter its header and content, modify the content if necessary, before putting it back to its communication path. In addition the server agent is responsible for collecting other performance data at a server and communicates with the client agent to gather complete data for rending a page.

According to some embodiments of the invention, the server-side monitoring includes a network-based probe on the server side. This can be a probe that is attached to a proxy box attached to the network to intercept the traffic or a probe box attached to the network directly, filtering and modifying the data as necessary. This eliminates the need to install the server agent on each of the Web servers selected for monitoring users experience and performance. However, its monitoring is limited since it cannot get as much information as a server-based module, e.g. the log file of the Web server and its operating system.

In some embodiments the client agent software is transmitted to a user's client computer, upon a user requesting a Web page, by a server agent that embeds the software in the Web page. The client agent software is embedded in the HTML file as a script executable by common browsers requiring no special run-time environment to be loaded. This method is non-intrusive and requires no permission or intervention by users while requesting Web pages to be rendered for viewing.

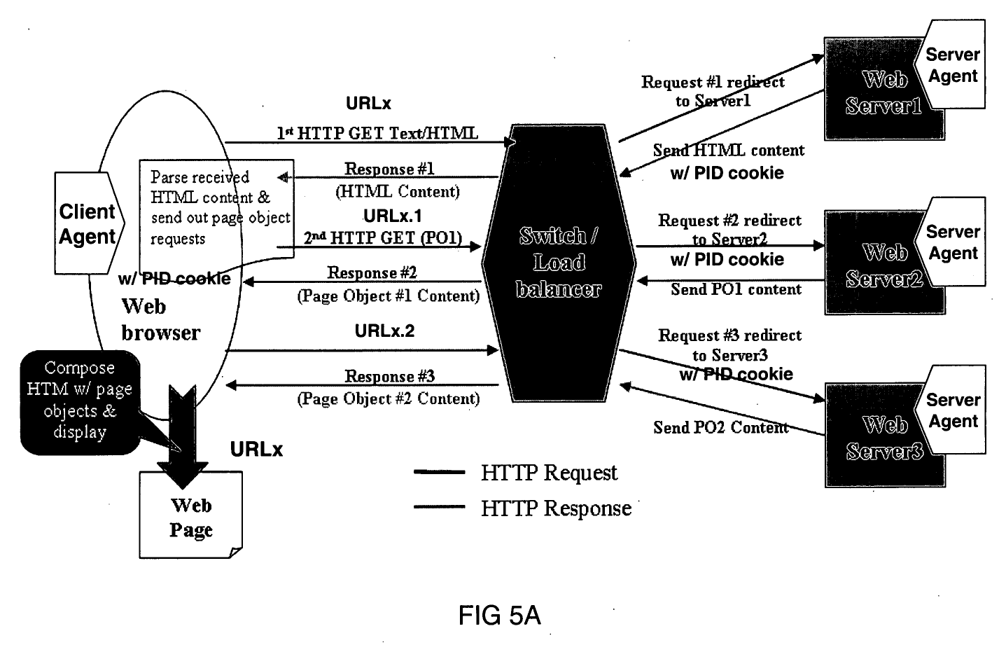

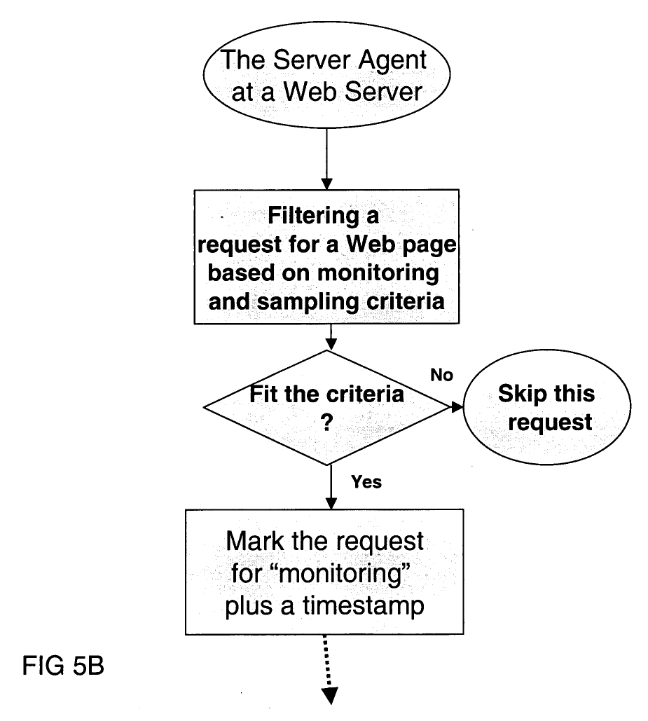

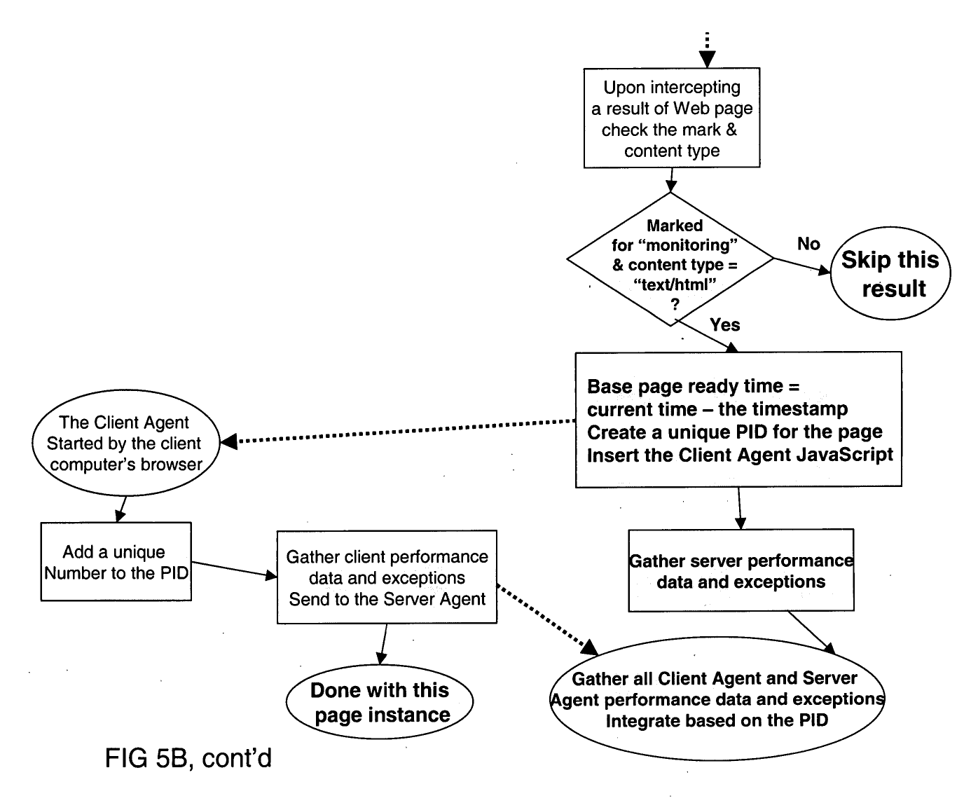

According to some embodiments of the invention, the client agent is a JavaScript, but it may be other scripts such as VB Script or other programming languages, inserted into each HTML base page to be monitored. This applies to the base page or one of the frames within a base page clicked for viewing by the user. The client agent is responsible for monitoring the client-side performance data and communicating with the server agent through the use of cookie and HTTP requests. The unique PID for each instance of a Web page access is also kept in the cookie when the page is set for monitoring. FIG. 5A shows how such a Web page for monitoring, borrowing from FIG. 2, causes a unique PID to be generated and placed in a cookie created for the monitoring purpose according to some embodiments of the invention. To respond to the first request for the Web page URLx the server agent creates and returns a unique PID with the HTML base page to the client computer.

A cookie with the HTTP communication provides a general mechanism for communicating information between a client computer and a server and it is transmitted with the requests from the client computer to the servers for serving the requests for objects as long as the requests belong to the same domain as the cookie. Cookies are well known in the art and no further details are necessary.

Although the requests for objects on the page, such as URLx.1 and URLx.2, are distributed to multiple Web servers, such as Web Server 2 and Web Server 3 in FIG. 5A installed with the server agent, the same PID cookie always goes with each request to a server agent, providing necessary information for the server agents to correlate the performance data of the base page and all its objects. This is because that once a cookie is created for a client computer accessing a Web page it goes with all requests for the same page from the client computer's browser to the Website and all the Web servers serving the object requests.

Each cookie set up for communications between a client agent and server agent may be limited by its allowable maximum size. The server agents involved may need to trim the cookie space by removing cookies and information in cookies that are no longer in use.

The insertion of the client agent software in the HTML page is non-intrusive to users and requires no permission or special run-time environment of the client computer other than the browser itself. The Web pages are edited to include the script of the client agent software in such a manner as to ensure that no business logic on the pages is altered or may break when rendered to the client computers.

According to some embodiments of the invention, the server agent dynamically inserts the client agent software script into a Web page upon a request for the Web page and the modified HTML base page is sent back to the client computer. This eliminates any editing efforts and possible errors introduced by the editing process.

FIG. 5B illustrates a communication process between the server agent and the client agent created by the server agent for each instance of a page selected for monitoring according to some embodiments of the invention. The selection of a Web page instance for monitoring is based on the monitoring and sampling criteria described earlier. When a request for a page is filtered and selected for monitoring by the server agent, the server agent marks it for “monitoring” with a timestamp of the current time. Later, when the Web server is ready to return the result to the client computer the result again is intercepted by the server agent. The server agent first checks if the result is a valid HTML base page such as checking its content of “text/html” and the mark for “monitoring”. If Yes to both checks it is the base of a Web page being monitored. The server agent calculates the base page service time by the Web server, that is, the current time minus the timestamp stored with the request earlier. The server agent then creates a unique PID for the page instance and inserts the client agent JavaScript plus the unique PID into the base page to be returned to the requesting client computer's browser.

The client agent when started by the browser processing the base page first enhances the uniqueness of the PID by appending another unique ID generated at the client computer side and storing it in the PID cookie according to some embodiments of the invention. The client agent and the server agent then work in tandem for gathering the client-side and server-side performance data including exceptions. Finally, the client agent uploads all data to the server agent for the server agent to correlate all data and integrate them for each page instance based on its unique PID.

The server agent at the end of each page rendering gathers and integrates all data from the client agent and the server agent. Since there could be multiple Web servers selected for monitoring users experience and thus multiple server agents involved in measuring performance data only one of the server agents needs to take the role of integrating all data together including data from all the server agents based on the page instance's PID. This server agent may be the one that first received the first request for the base page of the Web page as shown in FIG. 5B. Alternatively, the server agent may be any one of the server agents that is designated for integrating and correlating performance data. Each of the other server agents is requested to send its measurement data of the page objects measured at its server computer to the server agent requesting for the data for integration and correlation at the end of the page rendering.

In some embodiments of the invention for sites that comprise many Web servers with heavy traffic or with the need for storing the monitoring data for long-term analysis and reporting, all performance data with page PIDs can be sent to a separate management and database server that is dedicated to performance data correlations, reporting and database storage. In this case all server agents involved in measuring performance data are requested by the management and database server to send in their data for integration and correlation. The management and database server may also be distributed among multiple computers to handle heavy workload.

In some embodiments the server agent creates a PID for the Web page and a PID as a frame ID for each of the frames. The client agent identifies the parent-child relationship between the Web page and each of its embedded frames. The client agent may also enhance the uniqueness of the frame ID. Take the example of FIG. 4B, where a page consists of two frames. PID1, PID1.1, and PID1.2 are generated by one or more server agents serving the requests from the client. The client agent determines PID1 is the parent of PID1.1 and PID1.2. This relationship along with the performance data measured for each of the frames is used by the server agent to correlate and integrate the performance data of the embedded frames into that of the Web page for complete performance data. Any performance problem with a page or with a particular frame of a page can be diagnosed. It will be appreciated by one skilled in the art that the embodiments of the invention may utilized frame IDs in the same manner as PIDs.

In some embodiments the dynamic insertion of the client software is done in more than one step: the first step is to insert a small, fixed number of lines called tags to each Web page as a minimum change. When the browser executes the page the tags inserted initially as part of the page in turn bring in the necessary client software for performing the client-side monitoring. This minimizes the change to the base page's HTML text and reduces the overhead of downloading the client agent JavaScript. Basically, the client agent JavaScript to be requested may be already downloaded and cached at the client computer reusable to future requests for the same JavaScript.

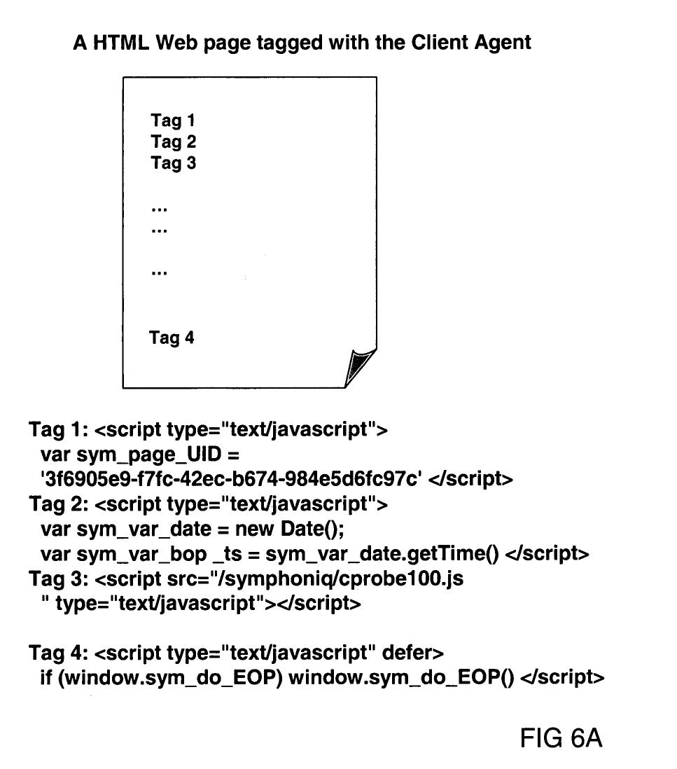

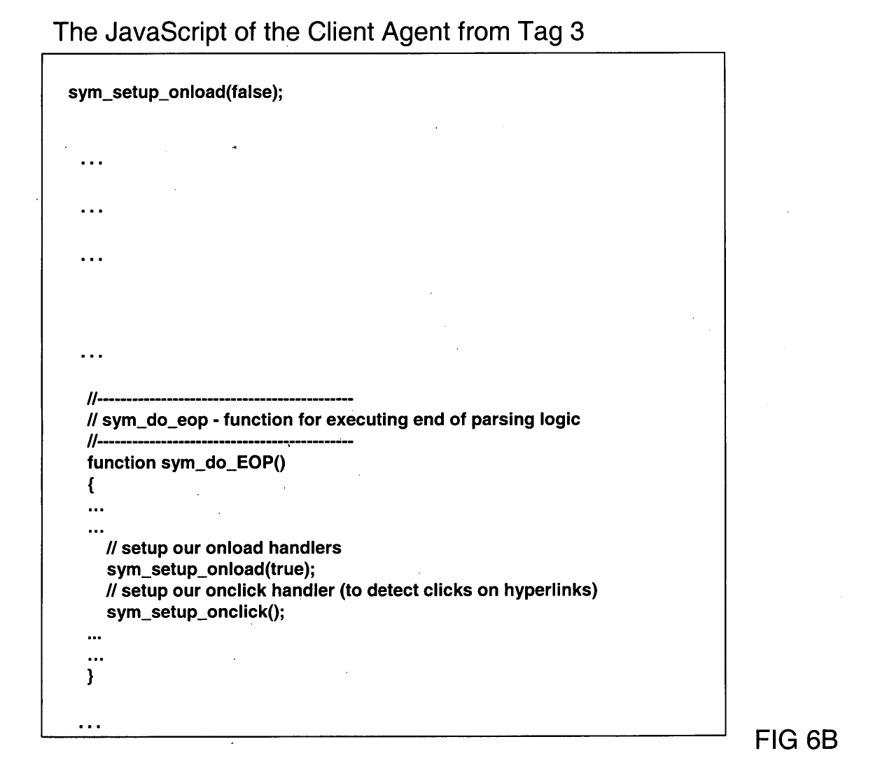

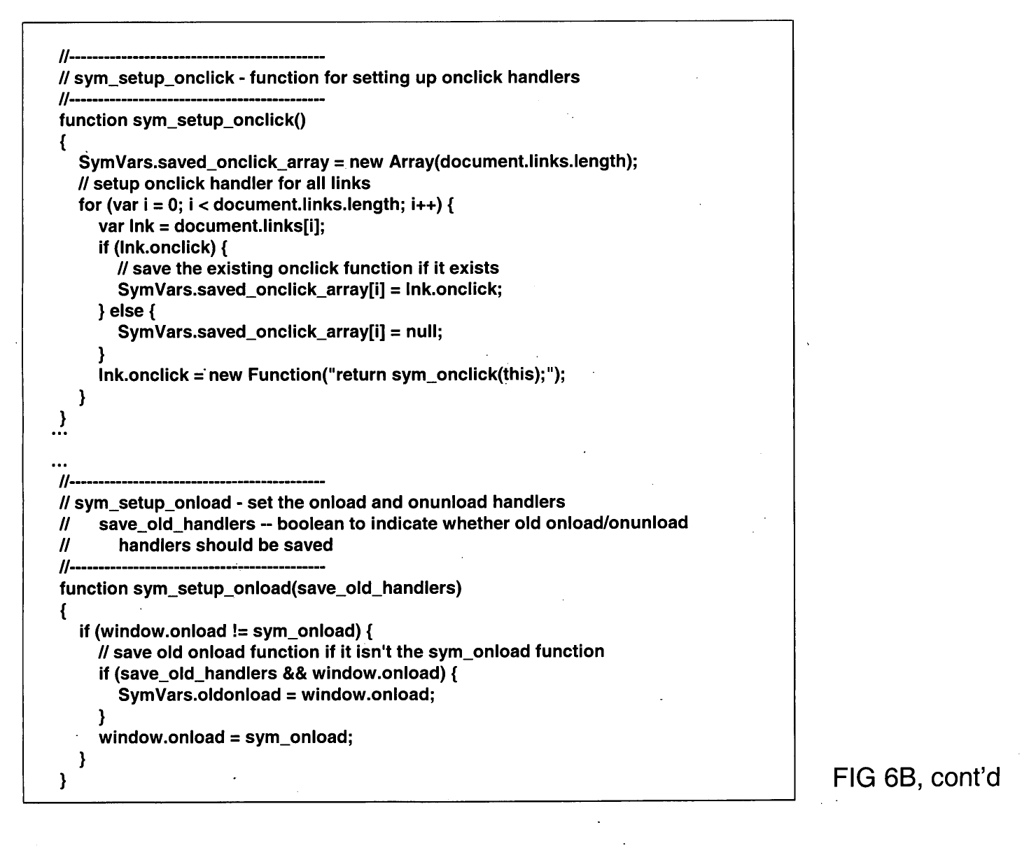

FIG. 6A shows examples of the four tags to be inserted to the HTML base page by the server agent according to some embodiments of the invention. Tag 1 is for setting the unique PID designated by the server agent for each instance of a Web page. Tag 2 obtains a timestamp consisting of the date and the time within the day as the beginning time of the base page processing at the client computer side. Tag 3 requests the client agent JavaScript to be loaded from the server agent in the next step. And, Tag 4 is placed at the end of the HTML page to ensure it is the last one of the page to be processed by the browser to deal with the setup of event handlers such as OnClick and OnLoad.

Tag 4 deals with the setup of the event handlers such as OnLoad and OnClick to help with the response time measurements of the page. The OnClick event is set up to capture the user's click to the next Web page.

FIG. 6B shows a sample copy of the client agent's JavaScript as loaded in by Tag 3 according to some embodiments of the invention. (The entire JavaScript code is available on the CD-ROM.) It executes the sym_setup_onload at the beginning to set up the OnLoad event handler to ensure the OnLoad event can be captured prior to the end of the page processing. It also includes the function of sym_do_EOP to be called by Tag 4 to set up the event handlers again in case any existing HTML script in the base page also deals with related event handling and may override what the client agent's event handlers established at the beginning of the client agent JavaScript. Furthermore, the event handlers executed at the end of the HTML page processing need to ensure both monitoring event handlers and the existing event handlers are executed in an orderly fashion. The function sym_setup_onclick and function sym_setup_onload, called by sym_do_EOP which is called by Tag 4, serve as an example of saving existing event handlers that may already exist in the original HTML base page so that the new event handlers for monitoring, when invoked, can executed all those saved event handlers in an orderly fashion.

In an alternate embodiment Tag 2 may be removed from the HTML base page and its content may be included at the beginning of the client agent JavaScript, which is loaded by Tag 3. This way it eliminates the insertion of one tag to the base page but the time measurement is off by a small latency introduced by the download of the client agent JavaScript. Basically, the Tag 2 when becoming part of the client agent JavaScript is executed after the JavaScript is loaded in the next step, instead of being part of the HTML page that is loaded and executed in the first step. However, the latency caused by loading the client agent JavaScript is only for the first time of accessing any Web page selected for monitoring at a particular client computer. After that the client agent JavaScript is cached at the client computer side and it no longer needs to be loaded and thus the latency is eliminated.

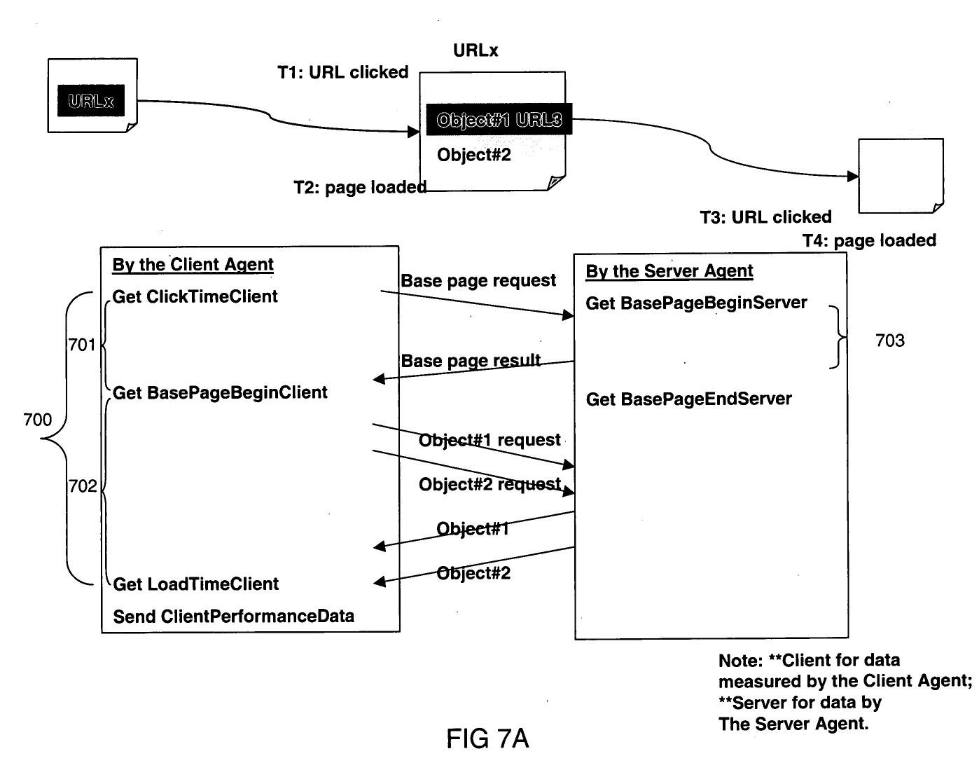

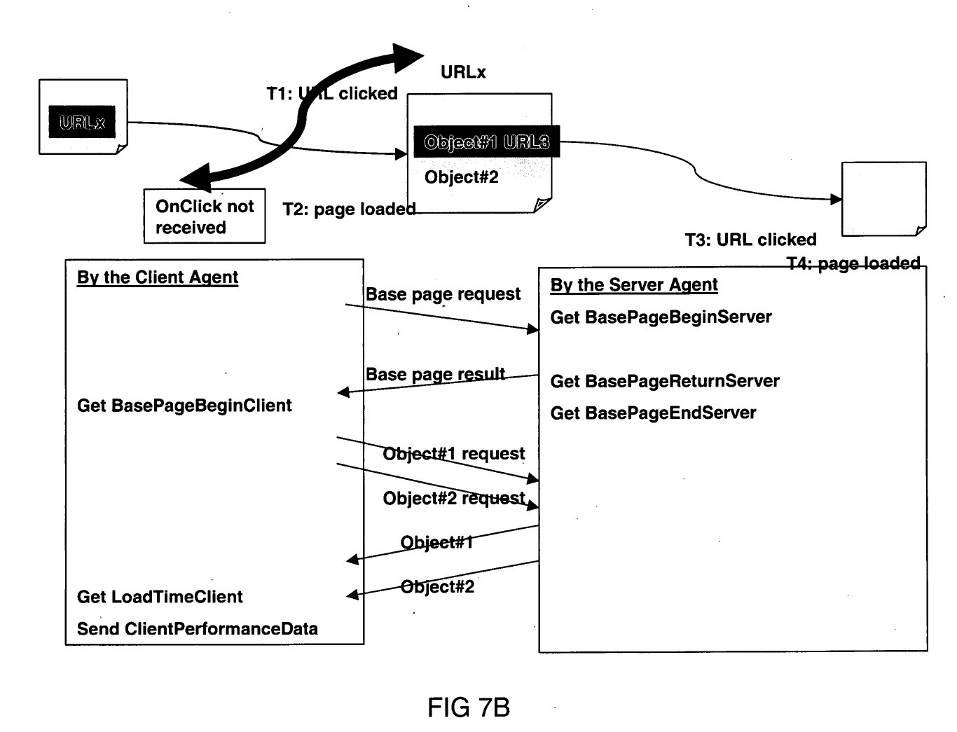

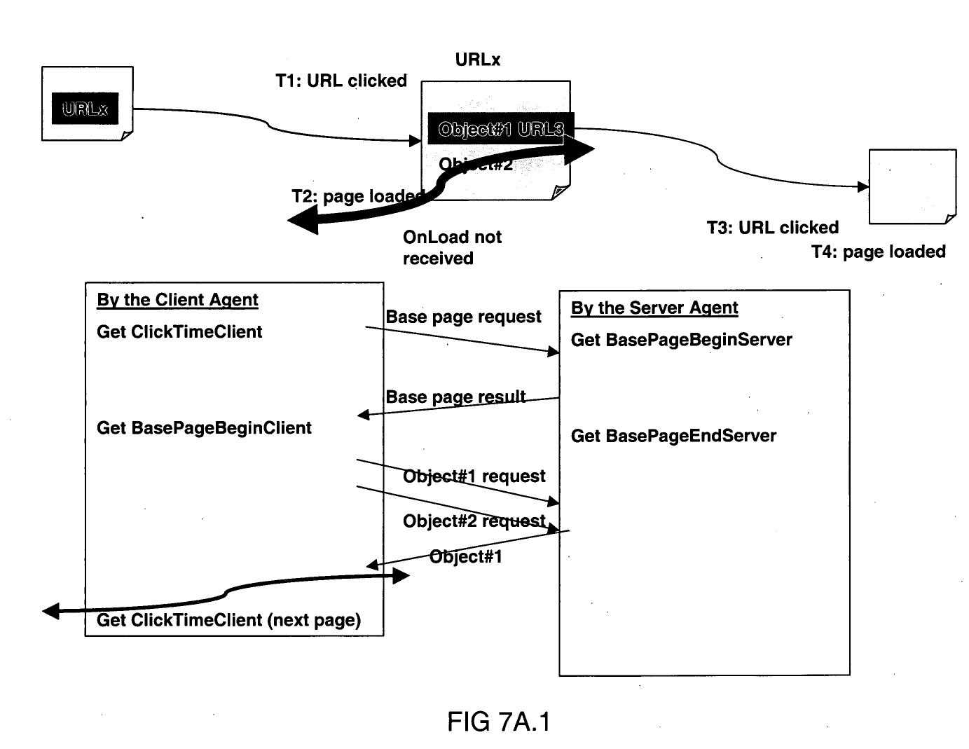

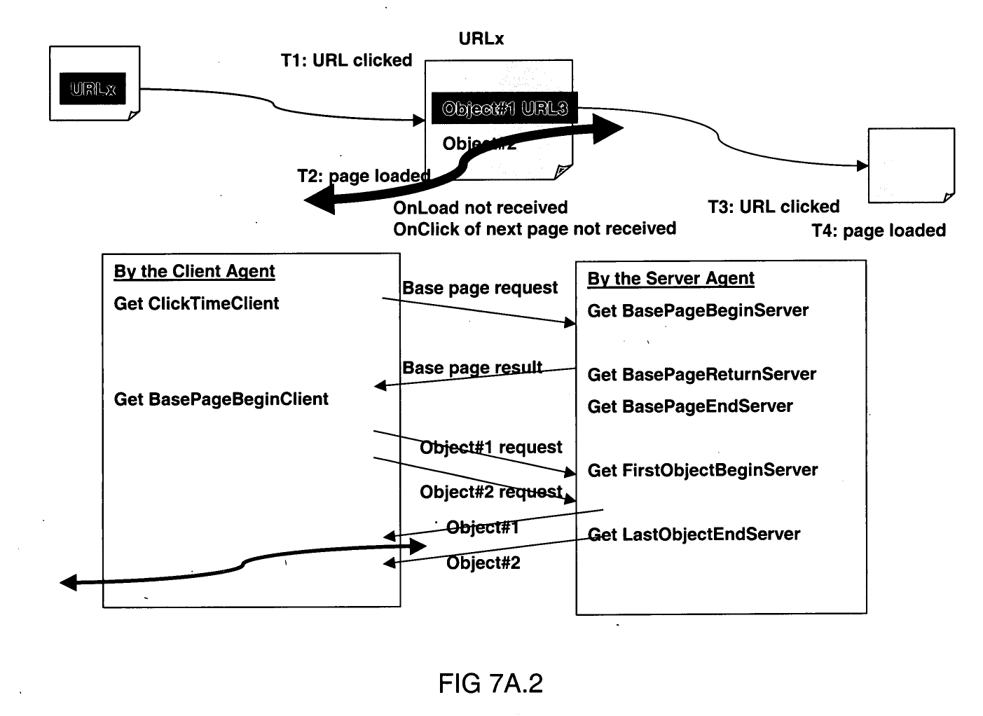

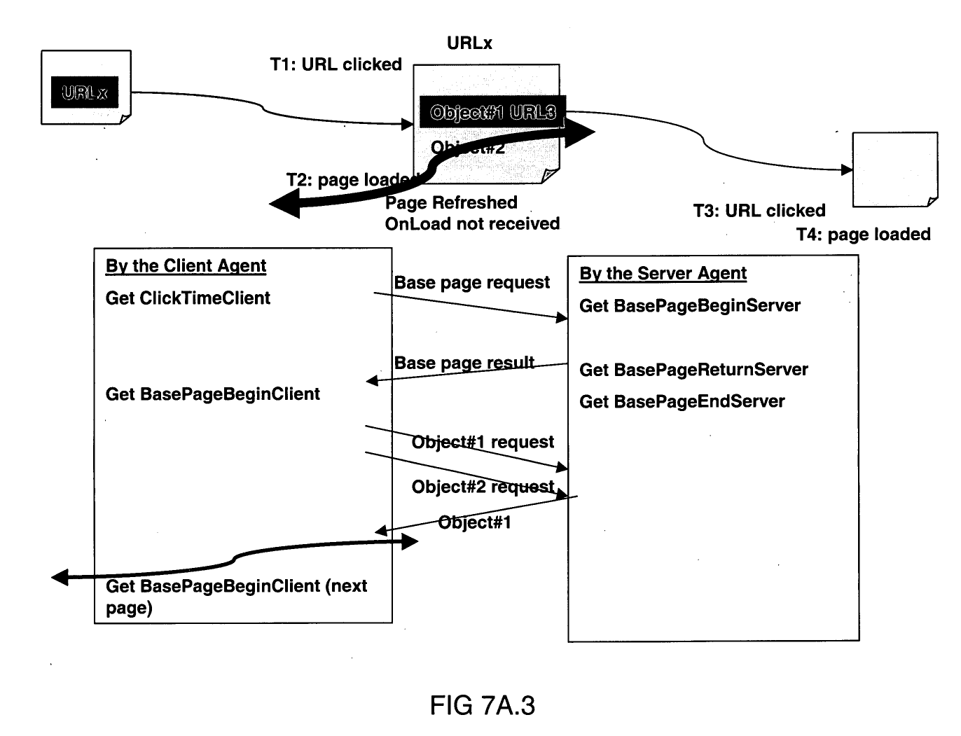

The client agent, in general, is responsible for gathering performance data for those HTML pages selected for monitoring users experience according to some embodiments. FIG. 4A, described earlier, illustrates a normal rendering process where the user clicks and views from one page to the next. And both the OnClick and the OnLoad events are triggered to activate their event handlers to stamp the time when the page link is clicked and the time when the page is fully loaded. FIG. 7A repeats this same process and assumes an HTML base page embedded with 2 objects as in FIG. 2. However, one skilled in the art can appreciate that the below equations can be applied to pages with a different number of objects and the embodiments of the invention are not limited to two objects.

The equations for the Web page rendering times according to some embodiments are:

ResponseTimeUser=LoadTimeClient−ClickTimeClient; BasePageServiceServer=BasePageEndServer−BasePageBeginServer;

TimeFirstByte=ResponseTimeUser−ObjectsServiceClient,

where ObjectsServiceClient=LoadTimeClient−BasePageBeginClient; and

ThinkTimeClient=ClickTimeClient (next page)−LoadTimeClient

In the above equations, “Client” denotes data measured at the client computer side by the client agent and “Server” denotes data at the server side by The server agent. The equations illustrate how the measurements by the client agent and the server agent are integrated together to determine the monitoring results.

ResponseTimeUser specifies the page rendering time at the user's client compuiter, measured from the OnClick time (ClickTimeClient) to the OnLoad time (LoadTimeClient). The client agent sends the performance data (ClientPerformanceData) to the server agent at the completion of the rendering.

ObjectsServiceClient is the time for processing all objects at the client computer, from receiving the first part of the base page for starting the base page processing (as timestamped by Tag 2 described earlier) (BasePageBeginClient) to the OnLoad time (LoadTimeClient).

BasePageServiceServer is the time for the base page processing at the server, from receiving the request of the base page (BasePageBeginServer), to the time of returning the base page to the client computer (BasePageEndServer).

TimeFirstByte is the time from the beginning of the page rendering to the time when the browser starts the base page processing, or ResponseTimeUser−ObjectsServiceClient.

ThinkTimeClient is the user's think time from the time the page is rendered till the time the user clicks for the next page, or ClickTimeClient (next page)−LoadTimeClient. This assumes that the rendering of the current page is complete and not interrupted by an exception by the user.

In an embodiment the rendering of the page is stopped by the user clicking the Stop button. The OnLoad event is available but a status of “page rendering incomplete” is available to signal the exception. Hence, the same equations stated here are still applicable.

According to some embodiments of the invention in certain cases where the OnClick is not available the server agent then gathers and supplements some of performance data that is usually gathered by the client agent. FIG. 7B shows a case of this when the click event of the current page is not received as shown by the thick double-arrowed interrupt line. This may occur when a new URL is entered (instead of a link within a page clicked) by the user or when the OnClick event handler has not been set up by the Web page proceeding the current Web page.

In this situation, the equations for the Web page rendering times according to some embodiments are:
ResponseTimeUser=BasePageReadyServer+ObjectsServiceClient+NetworkLatency;

Where BasePageReadyServer=BasePageReturnServer−BasePageBeginServer;

ObjectsServiceClient=LoadTimeClient−BasePageBeginClient; BasePageServiceServer=BasePageEndServer−BasePageBeginServer; TimeFirstByte=ResponseTimeUser−ObjectsServiceClient; and ThinkTimeClient=ClickTimeClient (next page)−LoadTimeClient

Only those equations that are different from those of FIG. 7A are described here:

ResponseTimeUser specifies the page rendering time at the user's client computer, consisting of the service time of the first part of the base page (BasePageReadyServer), all the objects' services time at client (ObjectsServiceClient) and the network latency.

BasePageReadyServer is the service time for the first part of the base page from the beginning of servicing the base page to the time when the first part of the base page is ready to be returned to the client, or BasePageReturnServer−BasePageBeginServer.

NetworkLatency is derived by the client agent and a server agent by measuring the round-trip time of a request between the client and a server.

There are other cases different from FIG. 7A, where the page rendering is interrupted by exceptions according to some embodiments of the invention. This causes the OnLoad event handler to not activate for measuring the load time. FIG. 7A.1 shows such an exception of the user's click-ahead for the next page, provided that the OnClick event handler for the next page is received and activated and thus it can be used for calculating the performance data of the interrupted current page.

In this situation, the equations for the Web page rendering times are: ResponseTimeUser=ClickTimeClient (next page)−ClickTimeClient; BasePageServiceServer=BasePageEndServer−BasePageBeginServer; TimeFirstByte=ResponseTimeUser−ObjectsServiceClient

where ObjectsServiceClient=ClickTimeClient (next page)−BasePageBeginClient.

Only those equations that are different from those of FIG. 7A are described here:

ResponseTimeUser specifies the page rendering time at the user's client computer, measured from the page's OnClick time (ClickTimeClient) to the next page's click time, (ClickTimeClient) (next page).

ObjectsServiceClient is the time for processing all objects at the client computer, from receiving the base page (BasePageBeginClient) to the next page's click time, (ClickTimeClient) (next page).

FIG. 7A.2 shows another exception where the page rendering is interrupted by the user's entering a new URL, and thus the OnLoad event of the current page and the OnClick event of the next page are not received according to some embodiments of the invention. The server agent needs to supplement for the missing data of the client agent by estimating the service time of the objects at the client computer. Basically, the client agent in this case is not able to send performance data and the server agent is responsible for estimating the performance data for the client computer.

In this situation, the equations for the Web page rendering times are: ResponseTimeUser=BasePageReadyServer+ObjectsServiceServer+NetworkLatency;

Where BasePageReadyServer=BasePageReturnServer−BasePageBeginServer;

ObjectsServiceServer=LastObjectEndServer−FirstObjectBeginServer+NetworkLatency;

BasePageServiceServer=BasePageEndServer−BasePageBeginServer;

TimeFirstByte=ResponseTimeUser−ObjectsServiceServer.

Only those equations that are different from those of FIG. 7A are described here:

ResponseTimeUser is the estimated page rendering time at the user's client computer, consisting of the service time of the first part of the base page (BasePageReadyServer), the objects' services time at the client estimated by the server agent (ObjectsServiceServer), and the network latency.

NetworkLatency is derived by the client agent and a server agent by measuring the round-trip time of a request between the client and a server.

ObjectsServiceServer is the time for processing all objects at the client computer estimated by the server agent, from receiving the first page object request (FirstObjectBeginServer) to the time when the server is about to return the last object to the client computer (LastObjectEndServer), plus NetworkLatency to compensate for the network time.

TimeFirstByte is the time from the beginning of the page rendering to the time when the browser starts the base page processing as estimated by the server agent, or ResponseTimeUser−ObjectsServiceServer.

FIG. 7A.3 shows yet another exception of the user's click on the Refresh button for the current page according to some embodiments of the invention. The Refresh action actually may abort the rendering of the current page but cause the process of the same base page to be started immediately for the next, refreshed page, whose time thus can be used to signal the end of the rendering of the current page. This is because the current page may already be cached at the client computer so no request for the same base page is necessary. The client agent in this case detects that the rendering of the current page is aborted and followed by the beginning of the base page processing of the same Web page (referred to by the same URL). Hence, it can recognize this page is being refreshed.

In this situation, the equations for the Web page rendering times are: ResponseTimeUser=BasePageReadyServer+ObjectsServiceClient+NetworkLatency;

Where BasePageReadyServer=BasePageReturnServer−BasePageBeginServer;

ObjectsServiceClient=BasePageBeginClient(next page)−BasePageBeginClient;

BasePageServiceServer=BasePageEndServer−BasePageBeginServer; TimeFirstByte=ResponseTimeUser−ObjectsServiceClient

Only those equations that are different from those of FIG. 7A are described here:

ResponseTimeUser estimates the page rendering time at the user's client computer, consisting of the service time of the first part of the base page (BasePageReadyServer), the objects' services time at the client (ObjectsServiceClient), and the network latency.

NetworkLatency is derived by the client agent and a server agent by measuring the round-trip time of a request between the client and a server.

BasePageReadyServer is the service time for the first part of the base page from the beginning of servicing the base page to the time when the first part of the base page is ready to be returned to the client, or BasePageReturnServer−BasePageBeginServer.

ObjectsServiceClient is the time servicing all objects at the client, from receiving the base page (BasePageBeginClient) to the time when the current page is refreshed and reloaded for the browser to start the base page processing (BasePageBeginClient) (next page).

There are other cases where the OnClick event of the current page is not received and/or the OnLoad event not received as caused by exceptions, and other cases different from the normal rendering process. The measurements may be derived by referencing the equations from FIG. 7B and FIG. 7A.1, 7A.2, and 7A.3 and can be implemented by one skilled in the art.

The three Web page rendering times, ResponseTimeUser, BasePageServiceServer and TimeFirstByte, can be compared with respective thresholds for each monitored page instance and thus generate a percentage of threshold violations according to some embodiments:

% ResponseTimeUser

% BasePageServiceServer

% TimeFirstByte

In some embodiments the client agent and the server agent detect user actions of aborting the rendering of the Web page, such as entering a new URL, clicking the Stop button, clicking the Refresh button. If the new URL is pointed to a different Website it is considered as an abandonment. The results can be compared with respective thresholds to generate a percentage of threshold violations:

% Aborts

% Abandons

In addition the client agent and the server agent also detect errors during the page rendering related to Web server, browser, or HTTP/HTML according to some embodiments of the invention. For example, following is a list of errors detected by the SERVER agent at a Web server:

400 Bad Request

405 Method Not Allowed

408 Request Time-Out

504 Gateway Time-Out

505 HTTP Version Not Supported

The results can be compared with a threshold to generate a percentage of threshold violations:

% Errors

Furthermore, the client agent and the server agent measure the rate of pages and the rate of objects coming to a Website according to some embodiments of the invention, such as:

#pages/second

#objects/second

In summary, according to some embodiments the following is a list of Web page performance data including exceptions that is monitored by the client agent and the server agent:

ResponseTimeUser

BasePageServiceServer

TimeFirstByte

% ResponseTimeUser

% BasePageServiceServer

% TimeFirstByte

% Aborts

% Abandons

% Errors

#pages/second

#objects/second

In addition to the Web page rendering times the server agent is also responsible for measuring the times of page objects, either objects of an HTML base page or objects embedded in a page according to some embodiments. Using the example of FIG. 5A of a base page with the two embedded objects, the server agent at each of the Web servers measures the following Web page object performance data:

For the first request of the base page URLx

ResponseTimeBasePageServer=BasePageServiceServer

The equation has been provided earlier: BasePageEndServer−BasePageBeginServer.

For object URLx.1 and URLx.2 respectively

ResponseTimeObjectServer=ObjectEndServer−ObjectBeginServer.

This measures the time from the beginning of servicing an object to the end of servicing the object at a server.

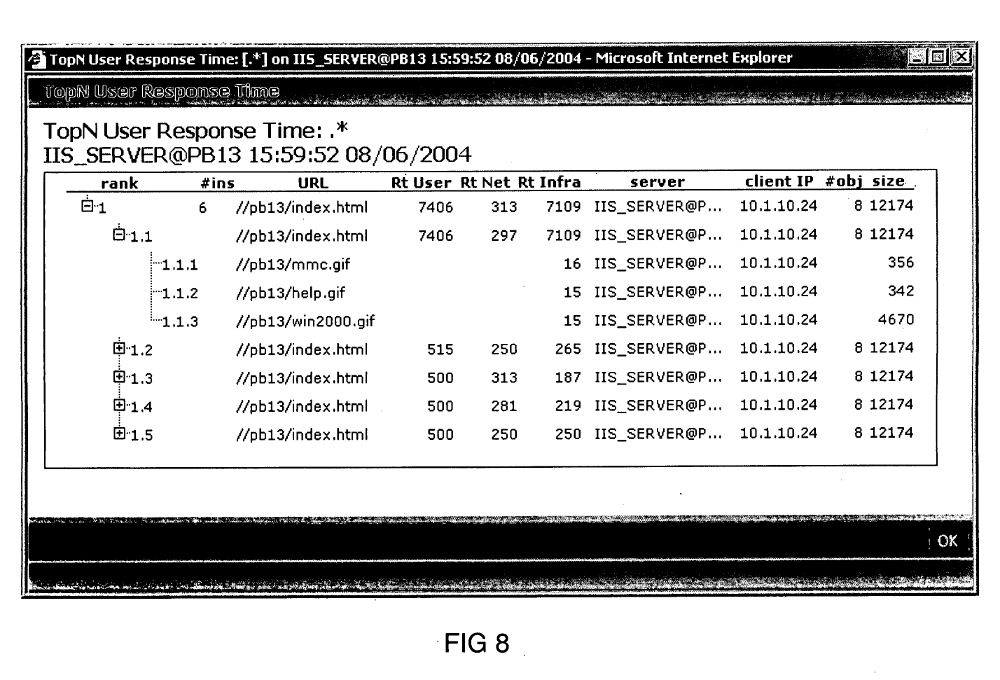

The list of performance data and exceptions that has been discussed so far is intended for users of the monitoring solution, primarily IT users, to monitor real users experience of a Website and diagnose problems when they occur. Another embodiment is to provide detailed information about each page instance when problems occurred including, for example, performance threshold violations or exceptions such as errors or user aborts. Specific instances of pages within a logical set that users have experienced problems with are determined, and additional performance data for those pages is provided to help IT users resolve the problems. For example, in case of a performance threshold violation its Top N detail information is provided based on the data gathered by the client agent and the server agent. FIG. 8 provides such a list that shows a specific Web page of//pb13/index.html with wich users have experienced performance problems. There are 6 instances of this particular page access, and five of them are displayed as indexed in 1.1, 1.2,1.3, etc. Furthermore, it displays the top N page objects of each instance, such as //pb13/mmc.jif, //pb13/help.gif, and //pb13/win2000.gif as indexed in 1.1.1, 1.1.2, and 1.1.3 respectively of the first page instance. Each page instance is provided with the page rendering times, ResponseTimeUser, ResponseTimeBasePageServer, Web server name, client computer's IP address, number of objects on the page, and page size. And each object instance is also provided with the object response time and object size.

In some embodiments IT people are able to resolve problems with a Website that cause users bad performance and exceptions by pin-pointing which server(s) may be causing the problems. This is important particularly when dealing with a Website infrastructure of multi-tiered servers, where customer-facing Web servers in the front tier are connected to application servers and/or database servers in the next tiers. An object of a page is usually served and composed by a Web server and some (or none) of application and database servers tiered together. Out of the excessive times if experienced in obtaining an object it is important to know how the times are divided among and attributed by those servers involved, thus identifying the cause of the performance problem.

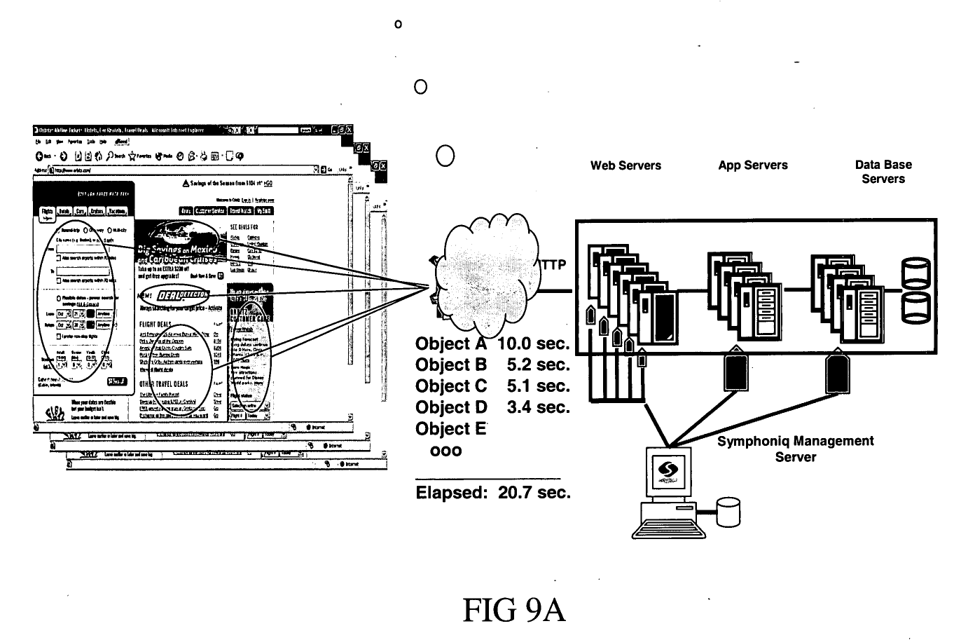

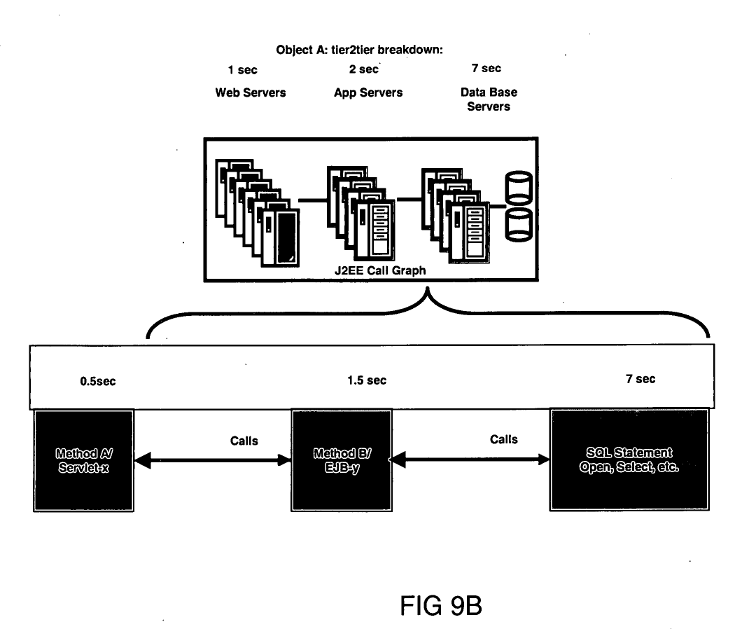

Most Websites have Web servers connected to application servers based on, for example, J2EE (Java 2 Platform, Enterprise Edition) or other object-oriented application servers such as Microsoft's NET, which may in turn be connected to other servers such as database servers, additional J2EE servers or non-J2EE servers. FIG. 9A provides an example where Web servers are connected to application servers, which in turn are connected to database servers according to some embodiments of the invention. For example, when a Web page's rendering time is detected at 20.7 seconds exceeding the threshold of 20 seconds as caused by the long rendering times of some of the objects embedded in the page, an IT user may want to trace down the tiered servers for problem resolutions. In this case Object A is the longest running object that takes 10 seconds as measured at a Web server. So the next thing is to find out how the excessive time is divided among the tiered application and database servers.

In some embodiments, a mark-and-trace method is used by marking each of the suspect objects with a unique application transaction-ID (or TID), and the TID is associated with the unique PID of its Web page. The TID is included in the header of the object request to be passed along to the application server connected to the Web server. To continue the monitoring with the tiered servers each application server is installed with another server agent called the Application Server agent (or ASP) that can handle the trace and measurements for both application and database servers.

A technique to implement the ASP to intercept requests sent to a Java application running on an application server is via byte-code-instrumentation (or BCI) according to some embodiments. This includes modification of the class loader of J2EE's Java Virtual Machine (or JVM) that is used to load the application onto the application server to run. One skilled in the art will appreciate that this technique can be implemented with a common application server. When the ASP based on the BCI is put in place it is ready to trace the calls started from the request that is marked for trace. It can trace the calls from one method of one class to another method of another class. During the trace it can timestamp the beginning and ending time of each call and thus get the execution times on each calling method or method being called. When one method is ready to make a call to a database, e.g. through the Java Database Connectivity (or JDBC) module to a connected database server, the JDBC written in Java can be instrumented with the BCI technique and thus monitored as another set of classes and methods. Hence, one method can be monitored for tracing its calls to a database on a remote database server, the times of the calls, and particular database queries (Open, Select, etc).

FIG. 9B shows when the request of Object A is marked with a TID for trace according to some embodiments. It is traced by the ASP for times spent on the connected applications and database servers before its result is returned to the Web server to be returned to the originating client computer's browser. The request for Object A is actually serviced by Method A and Method B, both reside on the same application server. Method B then makes a number of calls through the JDBC module on the same application server to the remote database server. The timing results are shown with the call graphs as measured by the ASP residing on the application server:

Request for Object A [symbol] Method A [symbol] Method B [symbol] Database server

The 10 Seconds consumed by Object A is broken down to the following:

Web server: 1 second

Application server: 2 seconds, 0.5 second by Method A and 1.5 second by Method B

Database server: 7 seconds

The classes and methods are further mapped onto the J2EE servlets and EJBs (enterprise Java beans) to provide additional information for problem resolutions, such as the class of Method A is mapped to Servlet-x and the class of Method B is mapped to EJB-y. Based on the results the responsible IT people, collaborating with the application developers, can resolve why Object A is taking so much time, where the time is spent (e.g. Database), and the detail information (such as the particular DB calls).

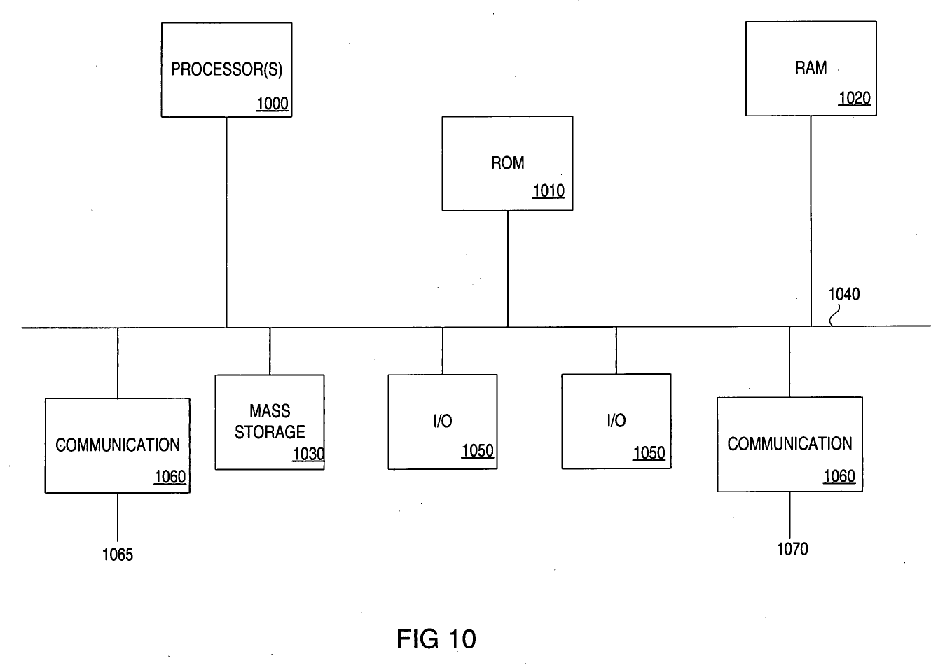

It will be appreciated that physical processing systems, which embody components of the monitoring system described above, may include processing systems such as conventional personal computers (PCs), embedded computing systems and/or server-class computer systems according to one embodiment of the invention. FIG. 10 illustrates an example of such a processing system at a high level. The processing system of FIG. 10 may include one or more processors 800, read-only memory (ROM) 810, random access memory (RAM) 820, and a mass storage device 830 coupled to each other on a bus system 840. The bus system 840 may include one or more buses connected to each other through various bridges, controllers and/or adapters, which are well known in the art. For example, the bus system 840 may include a ‘system bus’, which may be connected through an adapter to one or more expansion buses, such as a peripheral component interconnect (PCI) bus or an extended industry standard architecture (EISA) bus. Also coupled to the bus system 840 may be the mass storage device 830, one or more input/output (I/O) devices 850 and one or more data communication devices 860 to communicate with remote processing systems via one or more communication links 865 and 870, respectively. The I/O devices 850 may include, for example, any one or more of: a display device, a keyboard, a pointing device (e.g., mouse, touch pad, trackball), and an audio speaker.

The processor(s) 800 may include one or more conventional general-purpose or special-purpose programmable microprocessors, digital signal processors (DSPs), application specific integrated circuits (ASICs), or programmable logic devices (PLD), or a combination of such devices. The mass storage device 830 may include any one or more devices suitable for storing large volumes of data in a non-volatile manner, such as magnetic disk or tape, magneto-optical storage device, or any of various types of Digital Video Disk (DVD) or Compact Disk (CD) based storage or a combination of such devices.

The data communication device(s) 860 each may be any device suitable to enable the processing system to communicate data with a remote processing system over a data communication link, such as a wireless transceiver or a conventional telephone modem, a wireless modem, an Integrated Services Digital Network (ISDN) adapter, a Digital Subscriber Line (DSL) modem, a cable modem, a satellite transceiver, an Ethernet adapter, Internal data bus, or the like.

The term “computer-readable medium”, as used herein, refers to any medium that provides information or is usable by the processor(s). Such a medium may take many forms, including, but not limited to, non-volatile and transmission media. Non-volatile media, i.e., media that can retain information in the absence of power, includes ROM, CD ROM, magnetic tape and magnetic discs. Volatile media, i.e., media that cannot retain information in the absence of power, includes main memory. Transmission media includes coaxial cables, copper wire and fiber optics, including the wires that comprise the bus. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

Thus, methods and apparatuses for website performance monitoring have been described. Although the invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative sense rather than a restrictive sense.

What is claimed is:

1. A method of monitoring performance of rendering one or more web pages, the method comprising:
defining a logical set of web pages by selecting a subset of pages available on a website, wherein the logical set is identified by a naming string;
monitoring a web page of the logical set in response to a user requesting the page for viewing at a client computer, wherein the client computer requests each of the objects of the requested page from one or more server computers;
causing performance data to be collected by a client agent and one or more server agents during composing and presenting of the requested page, wherein the client agent resides and gathers performance data on the client computer and the server agents reside and gather performance data on the server computers; and
diagnosing problems experienced by the user in viewing the requested page by correlating the performance data collected by the client agent and the server agents.

2. The method of claim 1 wherein the naming string includes wild cards and regular expressions.

3. The method of claim 2 wherein the monitoring is based on, an adaptive monitoring and sampling criteria.

4. The method of claim 1 further comprising automatically identifying a subset of the logical set as a second logical set of pages with a new naming string for monitoring, wherein the subset is diagnosed with one or more performance problems.

5. The method of claim 4, wherein the second logical set of pages is automatically set for monitoring at a lower sampling rate than a sampling rate of the original logical set.

6. The method of claim 4 wherein the second logical set of pages is automatically set for monitoring at a higher sampling rate than a sampling rate of the original logical set.

7. The method of claim 1 wherein the pages are HTML pages.

8. The method of claim 1 wherein the naming string is based on URL.

9. The method of claim 1 wherein the logical set is based on a business group.

10. The method of claim 1 further comprising assigning a unique ID to each page by a server agent at a server computer serving user's request for the page.

11. The method of claim 10 further comprising enhancing the unique ID of each page by the client agent.

12. The method of claim 10 further comprising transmitting the unique ID with each request for an object of the page.

13. The method of claim 10 further comprising transmitting the unique ID in a cookie between the client agent and the one or more server agents.

14. The method of claim 1 further comprising assigning a unique frame ID to a frame embedded in the page and creating a parent-child relationship between the page and the frame.

15. The method of claim 1 further comprising transmitting client agent software by one or more server agents to the client computer upon receiving a first request for a page.

16. The method of claim 1 further comprising inserting one or more tags into the page by a server agent from one or more server agents upon receiving a first request for the page prior to transmitting the page to the client computer.

17. The method of claim 16 further comprising executing a tag from one or more tags by the client computer to request the client agent software to be transmitted to the client computer from one or more server computers.

18. The method of claim 1 further comprising presenting a list of performance data associated with instances of pages with problems experienced by the user during viewing.

19. The method of claim 18 further comprising presenting a list of objects which caused the problems experienced by the user during viewing.

20. The method of claim 1 wherein the one or more server computers are organized in a multi-tiered architecture.

21. The method of claim 20 wherein the diagnosing problems experienced by the user in viewing the requested page comprises correlating the performance data collected by server agents at server computers at all tiers servicing the request for the page.

22. The method of claim 21 wherein the server computers at all tiers include an application server computer.

23. The method of claim 21 wherein the server computers at all tiers include a database server computer.

24. The method of claim 21 wherein the diagnosing problems experienced by the user in viewing the requested page comprises identifying server computers from the server computers at all tiers servicing the request for the page that contribute to problems experienced by the user.

25. The method of claim 24 further comprising tracing and monitoring one or more applications servicing the request for the page at tiered server computers to identify application components that cause problems experienced by the user when viewing the page.

26. The method of claim 1 further comprising assigning a server from the one or more server computers to integrate and correlate the performance data collected by the one or more server agents.

27. A system for monitoring performance of rendering one or more web pages comprising:
a client agent to monitor and collect performance data of a user-requested web page from a logical set of web pages in response to the user requesting the web page for viewing at a client computer, the client agent further to collect performance data during the composing and presenting the web page to the user, wherein the logical set of web pages is a subset of pages available on a website and the logical set of web pages is identified by a naming string;
one or more server agents to monitor and collect performance data at one or more server computers during a composing and presenting the user-requested web page in response to a request for each of objects of the user-requested page; and
a server agent from the one or more server agents to correlate the performance data collected by the client agent and the one or more server agents to diagnose problems experienced by the user in viewing the user-requested web page.

28. The system of claim 27 further comprising the client agent and one or more server agents to monitor the user-requested web page based on an adaptive monitoring and sampling criteria.

29. The system of claim 27 further comprising the one or more server agents to assign a unique ID to the user-requested page of the logical set.

30. The system of claim 29 further comprising the client agent to enhance the unique ID of the user-requested page.

31. The system of claim 29 further comprising the one or more server agents to receive the unique ID in a cookie from the client agent.

32. The system of claim 27 wherein the logical set is based on a business group.

33. An article of manufacture comprising:
a computer-readable medium having stored therein a computer program executable by a processor, the computer program comprising instructions for:
defining a logical set of web pages by selecting a subset of pages available on a website, wherein the logical set is identified by a naming string;
monitoring a web page of the logical set in response to a user requesting the page for viewing at a client computer, wherein the client computer requests each of the objects of the requested page from one or more server computers;
causing performance data to be collected by a client agent and one or more server agents during composing and presenting of the requested page in both normal and exceptional cases, wherein the client agent resides and gathers performance data on the client computer and the server agents reside and gather performance data on the server computers; and
diagnosing problems experienced by the user in viewing the requested page by correlating the performance data collected by the client agent and the server agents.

34. The article of manufacture of claim 33 wherein computer program further comprises instructions for monitoring the page is based on an adaptive monitoring and sampling criteria.

35. The article of manufacture of claim 33 wherein computer program further comprises instructions for assigning a unique ID to the page by a server agent from the one or more server agents.

36. The article of manufacture of claim 35 wherein computer program further comprises instructions for enhancing the unique ID of the page by the client agent.

37. The article of manufacture of claim 33 wherein computer program further comprises instructions for transmitting the unique ID with each request for an object of the page.

38. The article of manufacture of claim 35 wherein computer program further comprises instructions for transmitting the unique ID in a cookie between the client agents and the one or more server agents.
